(19) United States
(12) Patent Application Publication
(10) Pub. No.: US 2017/0215466 A1
(43) Pub. Date: Aug. 3, 2017

(54) LOW CALORIE NUTRITIONAL COMPOSITIONS FOR MAINTAINING METABOLIC BALANCE

(71) Applicants: Children's Hospital & Research Center at Oakland, Oakland, CA (US); The United States of America, as Represented by the Secretary of Agriculture, Washington, DC (US)

(72) Inventors: Bruce Ames, Berkeley, CA (US); Mark Shigenaga, San Rafael, CA (US); Michele Mietus Snyder, Washington, DC (US); Joyce McCann, Walnut Creek, CA (US); Tara McHugh, Albany, CA (US); Donald A. Olson, Isleton, CA (US)

(21) Appl. No.: 15/419,579

(22) Filed: Jan. 30, 2017

Related U.S. Application Data
(63) Continuation of application No. 13/877,103, filed on Oct. 17, 2013, now abandoned.
(60) Provisional application No. 61/388,890, filed on Oct. 1, 2010.

(51) Int. Cl. A23L 33/00; A23L 33/15; A23L 33/21; A23L 33/12; A23L 33/16; A23L 33/175; A23L 33/105; A23L 33/155

(52) U.S. Cl. CPC A23L 33/40; A23L 33/105; A23L 33/15; A23L 33/155; A23L 33/12; A23L 33/16; A23L 33/175; A23L 33/21; A23V 2002/00

(57) ABSTRACT

The present invention provides nutritional compositions (for example, sensorially acceptable nutritional compositions) that comprise a fruit component, a fiber component, and a micronutrient component. Also provided are methods of making and using the nutritional compositions.

### CROSS-REFERENCE TO RELATED APPLICATIONS

This application claims priority to U.S. Application No. 61/388,890, filed on Oct. 1, 2011, which is hereby incorporated by reference in its entirety.

### TECHNICAL FIELD

The present invention relates to nutritional compositions (for example, sensorially acceptable nutritional compositions) that are useful for maintaining metabolic balance and reducing obesity and risk of diseases of aging, such as cardiovascular disease (CVD) and cancer in an individual as well as methods for manufacturing the same.

### BACKGROUND

Inadequate dietary intake of vitamins and minerals is widespread. In the Western world, this is most likely due to excessive consumption of energy-rich, micronutrient poor, refined food. For example, the leading dietary sources of energy in the United States are refined foods, which are abundant in carbohydrates and fats but low in micronutrients (essential vitamins, minerals, fatty acids, and amino acids), soluble and insoluble fibers, and other health-promoting food components such as polyphenols. Suboptimal consumption of these ingredients often accompanies calorie excess and contributes to the pathologies associated with obesity. Deficiencies in some micronutrients cause DNA damage, such as chromosome breaks, in cultured human cells or in vivo. Some of these deficiencies also cause mitochondrial decay with oxidant leakage and cellular aging, and are associated with late onset diseases such as cancer, heart disease, dementia, and diabetes.

In 2006, we proposed the “triage theory” to explain the long term effect of micronutrient deficiency. Ames, Proc. Natl. Acad. Sci. USA, 103(47):17589-17594, 2006. It was proposed that, as a result of recurrent shortages of micronutrients during evolution, natural selection developed a metabolic rebalancing response to these shortages. The rebalancing favors micronutrient-dependent proteins needed for short-term survival while starving those only required for long term health. The “triage theory” predicts that the consequence of moderate shortages of one or more micronutrients, though insufficient to cause overt clinical symptoms, will impair functions essential for long term health. This impairment will result in insidious damages (e.g., DNA damage) that, over time, lead to the acceleration of age-associated diseases (e.g., increased cancer).

Currently, multivitamin/mineral (MVM) pills are the most popular sources of micronutrients. However, some micronutrients such as omega-3 fatty acids, vitamin K, as well as minerals such as potassium are rarely included in such pills, in part because of adverse flavors and odors associated with these micronutrients. Some micronutrients are not included due to practical reasons such as bulkiness and palatability. Some micronutrients are not included because they are not believed to be deficient in humans. There may also be concerns about potential interactions among certain micronutrients when included in a single composition. MVM pills also frequently do not contain non-micronutrient ingredients, some of which may be important for maintaining an optimal metabolic balance and reducing risk of diseases.

Many nutrition bars containing micronutrients are available on the market. These include, for example, Dr. Sear™ OmegaZone Bars, ExtendBar Sugar-free Chocolate Delight, CocoaCassava™ Bar, NuGo Organic Nutrition Bar, Aristo Health Wellness Bar, Dexatrim™ All in One Energizing Diet Bar, and Heart Bar. Most of these nutrition bars, however, are designed to boost energy and/or supplement macronutrients such as proteins. None of these bars are designed specifically for promotion and maintenance of an optimal metabolic balance that may reduce the risk of chronic diseases. Furthermore, flavor and odor issues associated with incorporation of the diverse array of ingredients necessary to produce a sensorially acceptable composite bar have been insurmountable in the past.

The disclosures of all publications, patents, patent applications and published patent applications referred to herein are hereby incorporated herein by reference in their entirety.

### BRIEF SUMMARY OF THE INVENTION

The present invention provides a nutritional composition (for example, a sensorially acceptable nutritional composition) comprising: a) a fruit component comprising a polyphenol (such as a flavonoid, for example, anthocyanidin); b) a fiber component comprising a viscous soluble fiber (for example, a fermentable viscous soluble fiber); and c) a micronutrient component, wherein the micronutrient component comprises 1) at least one micronutrient that improves mitochondrial health in an individual; 2) at least one micronutrient that reduces inflammation in an individual; 3) at least one micronutrient that improves immune status in an individual, 4) at least one micronutrient that improves the redox status or antioxidant defense mechanism, and/or 5) at least one micronutrient that improves gut health. In some embodiments, the micronutrient component further comprises 6) at least one micronutrient that improves lipid metabolism, 7) at least one micronutrient that increases satiety, and/or 8) at least one micronutrient that improves maintenance of DNA integrity. In some embodiments, there is provided a nutritional composition (for example, a sensorially acceptable nutritional composition) comprising: a) a fruit component comprising polyphenol (such as a flavonoid, for example, anthocyanidin); b) a fiber component comprising a viscous soluble fiber (for example, a fermentable viscous soluble fiber), and c) a micronutrient component, wherein the micronutrient component comprises 1) at least five vitamins; 2) at least three minerals; and 3) at least one omega-3 long chain polyunsaturated fatty acid (LCPUFA). In some embodiments, the nutritional composition further comprises at least one amino acid (for example at least one essential amino acid). In some embodiments, the micronutrient component further comprises a salt, such as an acetate or a lactate (such as L-lactate). In some embodiments, the composition is free or substantially free of gluten. In some embodiments, the composition is free or substantially free of wheat.

In some embodiments, the nutritional composition further comprises chocolate, such as dark chocolate or non-alkali processed dark chocolate.

In some embodiments, the fruit component is at least about 5%, 10%, 15%, 20%, 25%, 30%, or 40% (w/w) of the composition, including any percentages in between these values. In some embodiments, the fruit component is at least about 10% (w/w) of the composition. In some embodiments, the fruit component comprises a concentrate from at least one berry fruit (such as blueberry). In some embodiments, the fruit component comprises a dried fruit powder from at least one fruit (such as a berry, for example, blueberry). In some embodiments, the fruit component comprises potassium.

In some embodiments, the viscous soluble fiber (for example, a fermentable viscous soluble fiber) is at least about 2.5%, 5%, 7.5%, 10%, 12.5%, 15%, 20%, 25%, 30%, 35%, 40%, 45%, or 50% (w/w) of the composition, including any percentages in between these values. In some embodiments, the viscous soluble fiber (for example, a fermentable viscous soluble fiber) component is at least about 5% (w/w) of the composition. In some embodiments, the fermentable viscous soluble fiber is β-glucan. In some embodiments, the viscous soluble fiber is fermentable. In some embodiments, the viscous soluble fiber is non-fermentable.

In some embodiments, the composition further comprises a water insoluble fiber. In some embodiments, the water insoluble fiber component is at least about 5%, 10%, 15%, 20%, 25%, 30%, or 40% (w/w) of the composition, including any percentages in between these values. In some embodiments, the water insoluble fiber is wheat bran. In some embodiments, the water insoluble fiber is rice bran. The bran can be ground to different sizes to affect final product properties.

The micronutrient component in some embodiments comprises at least five vitamins, at least three minerals, and at least one omega-3 long chain polyunsaturated fatty acid (LCPUFA). In some embodiments, at least one of the vitamins is selected from the group consisting of β-carotene, MK7, and 5-methyl-tetrahydrofolate. In some embodiments, the micronutrient component comprises at least five vitamins listed in Table 1. In some embodiments, the micronutrient component comprises at least three minerals listed in Table 2. In some embodiments, the micronutrient component comprises all ingredients listed in Table 1. In some embodiments, the micronutrient component comprises all ingredients listed in Table 2. In some embodiments, the micronutrient component comprises all ingredients listed in Table 1 and Table 2. In some embodiments, the micronutrient component comprises at least one amino acid (for example at least one essential amino acid).

In some embodiments, the LCPUFA is DHA. In some embodiments, the composition further comprises chocolate (such as dark chocolate, non-alkali processed chocolate, or non-alkali processed dark chocolate). In some embodiments, the LCPUFA is physically trapped in the chocolate. In some embodiments, the other lipid soluble micronutrients in the composition are physically trapped in the chocolate. In some embodiments, both the LCPUFA and the other lipid soluble micronutrients are physically trapped in the chocolate. In some embodiments, the nutritional composition is in the form of a nutrition bar.

In some embodiments, the composition further comprises coffee, vanilla, mint, cinnamon and/or food grade acids to obtain a sensorially acceptable final product. In some embodiments, the composition further comprises antioxidant rich spices such as, but not limited to, black pepper, cinnamon, cloves, garlic powder, ginger, oregano, paprika, rosemary, or tumeric.

Also provided herein are methods of using the nutritional compositions described herein in an individual (including a healthy individual). In some embodiments, there is provided a method of maintaining metabolic balance in an individual comprising administering any of the nutritional composition described herein to the individual. In some embodiments, there is provided a method for reducing risk of cardiovascular disease in an individual comprising administering a nutritional composition of any of the nutritional composition described herein to the individual. In some embodiments, there is provided a method for reducing risk of cancer in an individual comprising administering a nutritional composition of any of the nutritional composition described herein to the individual. In some embodiments, there is provided a method of reducing risk of diabetes, metabolic syndrome, or obesity in an individual comprising administering a nutritional composition of any of the nutritional composition described herein to the individual. In some embodiments, there is provided a method of improving cognitive function in an individual comprising administering a nutritional composition of any of the nutritional composition described herein to the individual. In some embodiments, there is provided a method of inducing weight loss in an individual comprising administering a nutritional composition of any of the nutritional composition described herein to the individual. In some embodiments, there is provided a method of reducing chronic inflammation in an individual comprising administering a nutritional composition of any of the nutritional composition described herein to the individual. In some embodiments, there is provided a method of increasing satiety in an individual comprising administering a nutritional composition of any of the nutritional composition described herein to the individual. In some embodiments, there is provided a method of preventing, decreasing the risk of, and/or improving cognitive function in an individual (such as an individual with dementia) comprising administering a nutritional composition of any of the nutritional composition described herein to the individual. In some embodiments, there is provided a method of improving lipid metabolism in an individual comprising administering a nutritional composition of any of the nutritional composition described herein to the individual. In some embodiments, there is provided a method of improving immunity (e.g., innate or adaptive immunity) in an individual comprising administering a nutritional composition of any of the nutritional composition described herein to the individual.

Further provided are methods of making the nutritional compositions described herein. In some embodiments, there is provided a method of making a nutritional composition (for example, a sensorially acceptable nutritional composition) comprising chocolate, LCPUFA and at least one other component (such as some of the nutritional compositions described herein), the method comprising: 1) melting the chocolate, 2) adding the LCPUFA to the melted chocolate, and 3) combining the LCPUFA/chocolate mixture with the other component in the composition. In some embodiments, the method further comprises solidifying the chocolate prior to combining the LCPUFA/mixture with the other component(s) in the composition. In some embodiments, the method further comprises adding one or more lipid soluble micronutrients, such as vitamin E, vitamin A, choline, DHA, and vitamin D, to the melted chocolate which surprisingly masks off flavors and odors commonly associated with these micronutrients This novel process also prevents oxidation of these nutrients during storage of the final products.

In some embodiments, there is provided a method of making a nutritional composition (for example, a sensorially acceptable nutritional composition) comprising a fruit and a micronutrient (such as any of the nutritional compositions described herein), comprising combining a freeze dried form of the fruit component (such as freeze dried berries, for example, freeze dried blueberries) with the micronutrient (such as the micronutrient component described herein) and macronutrient components which surprisingly masks off flavors and odors commonly associated with many dry micronutrients. This combination also results in an unexpected optimal texture in the final bar product.

The present application also provides kits and unit doses for the nutritional compositions described herein, including for example sealed packages comprising a nutritional composition described herein, such as a package sealed under nitrogen.

### BRIEF DESCRIPTION OF FIGURES

FIG. 1A shows the statistically significant (p=0.018) rise in HDL observed in a two-week trial with eleven healthy adults eating an exemplary composition of the present invention twice a day.

FIG. 1B shows the statistically significant (p=0.004) decrease in homocysteine in a two-week trial with eleven healthy adults eating an exemplary composition of the present invention twice a day.

FIG. 2 depicts plasma concentrations of HDL-c in 25 generally healthy individuals in pooled results from three 2-week trials. HDL-c concentrations levels before and after the intervention were plotted for each trial participant in the order of rising baseline values. Each arrow depicts the direction and the magnitude of the change in HDL-c, with the base of the arrow depicting the individual's baseline concentration and the head of the arrow the corresponding post intervention value. The nutrition bar intervention produced an overall increase in HDL-c (+3.5±4.8 mg/dl; p=0.001, paired t-test). The dotted lines represents cut-offs for tHcy, with values greater than 10 μmole/L representing moderate cardiovascular disease risk, and values greater than 15 μmole/L representing higher cardiovascular disease risk.

FIG. 3 depicts plasma homocysteine (tHcy) concentrations in 25 generally healthy individuals in pooled results from three 2-week trials. Plasma tHcy levels before and after intervention were plotted in each study participant in the order of rising baseline HDL-c levels. The nutrition bar intervention produced an overall decline in plasma tHcy (−2.176±3.6 μmole/L; p<0.05, paired t-test). The dotted line represents the cut-off for tHcy, with values less than 10 μmole/L representing higher cardiovascular disease risk.

FIG. 4A depicts nutrition bar consumption increases large buoyant HDL 2b subclass in plasma. Differences in the particle number concentration of HDL 2b, the most anti-atherogenic member of the class of large buoyant HDL, were plotted in the same study participant order as in FIG. 2. The direction and the magnitude of the change were plotted with the base and head of the arrow representing the pre- and post-intervention values, respectively. The nutrition bar intervention produced an overall increase of 25% in plasma HDL2b (+423.5±374.1 nmol/L; p<0.0001).

FIG. 4B shows a representative shift in mass distribution of HDL particles towards the HDL 2b subclass in one of six individuals in whom HDL-c decreased or was unaltered by the intervention. Representative HDL particle size distribution was evaluated in one individual by ion mobility particle analysis. Preintervention and postintervention plots are highlighted with the change between the two profiles shown in the inset. In this and each of the six cases in which HDL-c decreased or was unaltered by intervention, a consistent increase in the particle mass of the larger more buoyant HDL 2b subclass was observed.

FIG. 5 show the correlation between percent changes in HDL-c and HDL-2b. To evaluate the sensitivity of HDL-c and HDL-2b to biomark the effects of the nutrition bar on lipid handling, the postintervention changes were calculated and the correlation between the two variables plotted. The change was calculated for each variable by subtracting the baseline from the corresponding postintervention value and expressing this change as a percent difference. The slope of the plot indicates that HDL-2b is more sensitive than HDL-c in biomarking the lipid handling benefits of the bar.

FIG. 6 depicts the statistically significant (p=0.01) decline in LDL cholesterol observed in a 2-month trial in healthy adults utilizing an exemplary nutrition bar composition containing a mixture of a soluble nonfermentable fiber (β-glucan) and the highly viscous soluble nonfermentable fiber hydroxyprophylmethylcellulose (HPMC).

FIG. 7 depicts the statistically significant (p=0.04) decline in insulin resistance observed in a 2-month trial in healthy adults utilizing an exemplary nutrition bar composition containing a mixture of a soluble nonfermentable fiber (β-glucan) and the highly viscous soluble nonfermentable fiber hydroxyprophylmethylcellulose (HPMC)

FIG. 8 depicts a favorable decrease in diastolic blood pressure in adults following a 7-week trial wherein 2 nutrition bars per day were consumed by obese parents (n=12) and their adolescent children (n=13) who, as family groups, attended weekly nutrition education and exercise classes. A control group of parents (n=9) and adolescent children (n=9) also attended separate but identical classes but did not eat the bars.

FIG. 9 shows a favorable decrease in systolic blood pressure in adolescents following a 7-week trial wherein 2 nutrition bars per day were consumed by obese parents and their adolescent children, who, as family groups, attended weekly nutrition education and exercise classes. A control group of parents and adolescent children also attended separate but identical classes but did not eat the bars.

### DETAILED DESCRIPTION OF THE INVENTION

The present invention provides a fiber-enriched, low calorie, micronutrient fortified nutritional composition (for example, a sensorially acceptable nutritional composition) that simultaneously restores micronutrient adequacy, improves gut health, and maintains metabolic balance. The composition comprises a fruit component, a fiber component comprising a viscous soluble fiber (such as a fermentable viscous soluble fiber), and a micronutrient component comprising various vitamins, minerals, and at least one omega-3 long chain polyunsaturated fatty acid (LCPUFA). We found that consumption of such composition by healthy adults in multiple two-week to two-month in-house trials significantly improved biomarkers associated with reduced risk of various diseases including cardiovascular disease. Specifically, it was found that the nutritional composition raises HDL, improves the sizing profile of LDL (i.e., increases in the proportion of large buoyant LDL relative to small dense LDL, and the proportion of large buoyant HDL), and lowers homocysteine, and thus reduces risk of cardiovascular diseases and dementia. The nutritional composition also improves biomarkers linked to gut health and metabolic syndrome. In addition, we found that the nutritional composition increases satiety. All these observations were made in individuals eating a reasonably good diet.

The composition described herein may also lead to a reduction in DNA damage, reduction in inflammation, improvement in innate or adaptive immunity, improvement of cognitive function, induction of weight loss, improvement of vascular function, and improvement in metabolic syndrome markers such as blood pressure, ectopic adipose deposition, and insulin sensitivity.

We have surprisingly found that the fruit component, the fiber component, and the micronutrient component in the nutritional composition are all essential for the function of the nutritional composition. Specifically, a composition containing all the ingredients except for the fruit component and a fermentable viscous soluble fiber did not produce any statistically significant results in raising HDL. On the other hand, a composition containing only the fruit component and/or the fermentable viscous soluble fiber did not produce any statistically significant results. Substituting the fermentable, viscous soluble fiber in the fiber component with a non-viscous soluble fiber or a non-fermentable, viscous soluble fiber eliminated some or all of the effect of the composition. The specific combination of the fruit component, the fiber components, and the micronutrient component thus provides a unique composition that is useful for maintaining the metabolic balance and reducing risk of diseases (such as cardiovascular diseases) in a human individual, including a healthy human individual.

Thus, the present application in one aspect provides a nutritional composition comprising a fruit component, a fiber component, and a micronutrient component.

In another aspect, there are provided methods of maintaining metabolic balance and/or reducing risk of diseases in an individual (including, but not limited to, a healthy individual) by orally administering the nutritional composition to the individual.

Also provided are methods of making the nutritional compositions described herein.

### Definitions

A “fruit component” used herein refers to a fruit concentrate obtained from one or more fruits.

“A fruit” used herein refers to one particular kind of fruit.

A “fruit concentrate” or “a concentrate of a fruit” used herein refers generally to a condensed product derived from a fruit. The term “fruit concentrate” therefore encompasses fruit powder, fruit juice, fruit paste, fruit puree, fruit extract, dried fruit, etc. The fruit concentrate can be drum dried, freeze dried, spray dried or processed by other methods.

A “micronutrient component” used herein refers to a specific mixture of micronutrients that are added in addition to those inherently present in the fruit component and/or the fiber component. “Micronutrients” described herein include, but are limited to, vitamins, minerals, essential amino acids, and fatty acids.

The amount of a given micronutrient in the composition includes both those inherently present in the fruit component and/or the fiber component and those added as part of the micronutrient component. For example, a composition “comprises X amount of a micronutrient” means that the total amount of the micronutrient in the composition is X. A micronutrient component “comprises X amount of a micronutrient” means that the total amount of the micronutrient added in addition to those inherently present in the fruit component and/or the fiber component is X.

Similarly, the amount of a given fiber in the composition includes both those inherently present in the component and those added as part of the fiber component. For example, a composition “comprises X amount of an insoluble fiber” means that the total amount of the insoluble fiber in the composition is X. A fiber component “comprises X amount of an insoluble fiber” means that the total amount of the insoluble fiber added in addition to those inherently present in the fruit component is X.

The term “soluble” in the context of soluble fibers refers to the capability of the fiber to be solubilized in a buffer solution at a defined pH in accordance with the American Association of Cereal Chemists (AACC) Method 32-01.

A soluble fiber is “viscous” if the soluble fiber that has viscosity of at least about 100 mPa-sec.

A soluble fiber is “fermentable” if the fiber is digestible by the gut flora.

All percentages and ratios as used herein unless otherwise specified are by weight of the total composition unless otherwise specified. All such weight as they pertain to listed ingredients are based on the active level and therefore do not include the weight of carriers or impurities that may be included in the commercially available materials, unless otherwise specified.

Unless otherwise specified, the amounts of the ingredients described herein are provided based on suggested daily values. Thus, for example, a composition “comprises about 50 mg” of an ingredient means that the amount of the ingredient in a suggested daily unit dose of the composition is about 50 mg. The daily unit dose can be divided up into multiple unit form such as bars, pills, etc. The amount of the ingredient thus refers to the total amount of the ingredient in these multiple unit forms. By way of example, in some embodiments when the composition is provided in the forms of nutrition bars, and a daily suggested amount is two bars, the amount of the ingredient(s) provided herein refers to the amount of the ingredient in every two nutrition bars.

Percent “RDA” refers to the percentage of recommended daily amount for the specific ingredient. “AI” refers to adequate intake. The RDA and AI values of some of the ingredients discussed herein are provided in Table 8.

Reference to “about” a value or parameter herein includes (and describes) embodiments that are directed to that value or parameter per se. For example, description referring to “about X” includes description of “X.”

The compositions and methods of the present invention may be substantially free of a specific ingredient described herein. In this context, the term “substantially free” means that the compositions comprise less than about 2%, including less than about 0.5%, less than about 0.1%, or 0%, by weight of the specific ingredient.

The compositions and methods of the present invention may comprise, consist of, or consist essentially of the essential elements and limitations of the invention described herein, as well as any additional or optional ingredients, components, or limitations described herein or otherwise useful in a nutritional or pharmaceutical application.

### Nutritional Compositions

The present invention in some embodiments provides a nutritional composition comprising: a) a fruit component; b) a fiber component comprising a viscous soluble fiber (for example, a fermentable viscous soluble fiber such as β-glucan); and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanisms, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, there is provided a nutritional composition comprising: a) a fruit component; b) a fiber component comprising a viscous soluble fiber (for example, a fermentable viscous soluble fiber such as β-glucan); and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprises monomeric flavinoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising polyphenol; b) a fiber component comprising a viscous soluble fiber; and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprising polyphenol comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising polyphenol; b) a fiber component comprising a fermentable viscous soluble fiber (such as β-glucan); and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprising polyphenol comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising flavonoid (such as anthocyanidin); b) a fiber component comprising a viscous soluble fiber; and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising polyphenol (such as a flavonoid, for example, anthocyanidin); b) a fiber component comprising a fermentable viscous soluble fiber (such as β-glucan); and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprising polyphenol comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising a concentrate of a fruit comprising polyphenol; b) a fiber component comprising a viscous soluble fiber; and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprising a concentrate of a fruit comprising polyphenol comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising a concentrate of a fruit comprising polyphenol; b) a fiber component comprising a fermentable viscous soluble fiber (such as β-glucan); and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprising a concentrate of a fruit comprising polyphenol comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising a concentrate of a fruit comprising a flavonoid (such as anthocyanidin); b) a fiber component comprising a viscous soluble fiber; and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising a concentrate of a fruit comprising polyphenol (such as a flavonoid, for example, anthocyanidin); b) a fiber component comprising a fermentable viscous soluble fiber (such as β-glucan); and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprising a concentrate of a fruit comprising polyphenol comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising a concentrate from at least one (such as at least 2, 3, 4, 5, or 6) berry fruit; b) a fiber component comprising a viscous soluble fiber; and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments, the composition comprises: a) a fruit component comprising a concentrate from at least one (such as at least 2, 3, 4, 5, or 6) berry fruit; b) a fiber component comprising a fermentable viscous soluble fiber (such as β-glucan); and c) a micronutrient component, wherein the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and/or 5) at least one (such as at least about 2, 3, 4, 5, 6) micronutrient that improves gut health. In some embodiments, the micronutrient component further comprises 6) at least one (such as at least about 2, 3, 4, 5, 6) micronutrient that improves lipid metabolism, 7) at least one (such as at least about 2, 3, 4, 5, 6) micronutrient that improves satiety, 8) at least one (such as at least about 2, 3, 4, 5, 6) micronutrient that improves maintenance of DNA integrity, and/or 9) at least one (such as at least about 2, 3, 4, 5, 6) micronutrient that improves vascular function and blood pressure. In some embodiments, the fruit component comprises potassium. In some embodiments, the fruit component comprises monomeric flavonoid. In some embodiments, the fiber component further comprises insoluble fiber. In some embodiments, the composition further comprises a protein (such as whey protein). In some embodiments, the composition further comprises chocolate (such as dark chocolate).

In some embodiments there is provided a nutritional composition comprising: a) a fruit component; b) a fiber component comprising a viscous soluble fiber; and c) a micronutrient component, wherein the micronutrient component comprises: 1) at least five vitamins, 2) at least three minerals, and 3) at least one omega-3 long chain polyunsaturated fatty acid (LCPUFA). In some embodiments there is provided a nutritional composition comprising: a) a fruit component; b) a fiber component comprising a viscous soluble fiber; and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments there is provided a nutritional composition comprising: a) a fruit component; b) a fiber component comprising a fermentable viscous soluble fiber (such as β-glucan); and c) a micronutrient component, wherein the micronutrient component comprises: 1) at least five vitamins, 2) at least three minerals, and 3) at least one omega-3 long chain polyunsaturated fatty acid (LCPUFA). In some embodiments there is provided a nutritional composition comprising: a) a fruit component; b) a fiber component comprising a fermentable viscous soluble fiber (such as β-glucan); and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising polyphenol (such as a flavonoid, for example, anthcyanidin); b) a fiber component comprising a viscous soluble fiber; and c) a micronutrient component, wherein the micronutrient component comprises: 1) at least five vitamins, 2) at least three minerals, and 3) at least one omega-3 long chain polyunsaturated fatty acid (LCPUFA). In some embodiments, the composition comprises: a) a fruit component comprising polyphenol (such as a flavonoid, for example, anthocyanidin); b) a fiber component comprising a viscous soluble fiber; and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprising polyphenol comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA and/or other lipid soluble micronutrients are physically entrapped in the chocolate.

In some embodiments, the composition comprises: a) a fruit component comprising polyphenol (such as a flavonoid, for example, anthcyanidin); b) a fiber component comprising a fermentable viscous soluble fiber (such as β-glucan); and c) a micronutrient component, wherein the micronutrient component comprises: 1) at least five vitamins, 2) at least three minerals, and 3) at least one omega-3 long chain polyunsaturated fatty acid (LCPUFA). In some embodiments, the composition comprises: a) a fruit component comprising polyphenol (such as a flavonoid, for example, anthocyanidin); b) a fiber component comprising a fermentable viscous soluble fiber (such as β-glucan); and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprising polyphenol comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA and other lipid soluble micronutrients are physically entrapped in the chocolate.

In some embodiments, the composition comprises: a) a fruit component comprising flavonoid (such as anthocyanidin); b) a fiber component comprising a viscous soluble fiber; and c) a micronutrient component, wherein the micronutrient component comprises: 1) at least five vitamins, 2) at least three minerals, and 3) at least one omega-3 long chain polyunsaturated fatty acid (LCPUFA). In some embodiments, the composition comprises: a) a fruit component comprising polyphenol (such as a flavonoid, for example, anthocyanidin); b) a fiber component comprising a viscous soluble fiber; and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprising polyphenol comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA and other lipid soluble micronutrients are physically entrapped in the chocolate.

In some embodiments, the composition comprises: a) a fruit component comprising polyphenol (such as a flavonoid, for example, anthocyanidin); b) a fiber component comprising a fermentable viscous soluble fiber (such as β-glucan); and c) a micronutrient component, wherein the micronutrient component comprises: 1) at least five vitamins, 2) at least three minerals, and 3) at least one omega-3 long chain polyunsaturated fatty acid (LCPUFA). In some embodiments, the composition comprises: a) a fruit component comprising polyphenol (such as a flavonoid, for example, anthocyanidin); b) a fiber component comprising a fermentable viscous soluble fiber (such as β-glucan); and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprising polyphenol comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA and other lipid soluble micronutrients are physically entrapped in the chocolate.

In some embodiments, the composition comprises: a) a fruit component comprising a concentrate of a fruit comprising polyphenol (such as a flavonoid, for example, anthocyanidin); b) a fiber component comprising a fermentable viscous soluble fiber (such as β-glucan); and c) a micronutrient component, wherein the micronutrient component comprises: 1) at least five vitamins, 2) at least three minerals, and 3) at least one omega-3 long chain polyunsaturated fatty acid (LCPUFA). In some embodiments, the composition comprises: a) a fruit component comprising a concentrate of a fruit comprising polyphenol (such as a flavonoid, for example, anthocyanidin); b) a fiber component comprising a fermentable viscous soluble fiber (such as β-glucan); and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprising a concentrate of a fruit comprising polyphenol comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA and other lipid soluble micronutrients are physically entrapped in the chocolate.

In some embodiments, the composition comprises: a) a fruit component comprising a concentrate from at least one (such as at least 2, 3, 4, 5, or 6) berry fruit; b) a fiber component comprising a viscous soluble fiber; and c) a micronutrient component, wherein the micronutrient component comprises: 1) at least five vitamins, 2) at least three minerals, and 3) at least one omega-3 long chain polyunsaturated fatty acid (LCPUFA). In some embodiments, the composition comprises: a) a fruit component comprising a concentrate from at least one (such as at least 2, 3, 4, 5, or 6) berry fruit; b) a fiber component comprising a viscous soluble fiber; and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from at least one (such as at least 2, 3, 4, 5, or 6) berry fruit; b) a fiber component comprising a viscous soluble fiber; and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the composition further comprises an insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from at least one (such as at least 2, 3, 4, 5, or 6) berry fruit; b) a fiber component comprising a fermentable viscous soluble fiber (such as β-glucan); and c) a micronutrient component, wherein the micronutrient component comprises: 1) at least five vitamins, 2) at least three minerals, and 3) at least one omega-3 long chain polyunsaturated fatty acid (LCPUFA). In some embodiments, the composition comprises: a) a fruit component comprising a concentrate from at least one (such as at least 2, 3, 4, 5, or 6) berry fruit; b) a fiber component comprising a fermentable viscous soluble fiber (such as β-glucan); and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the fruit component comprises potassium. In some embodiments, the fruit component comprises monomeric flavonoid. In some embodiments, the fiber component further comprises insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from at least one (such as at least 2, 3, 4, 5, or 6) berry fruit; b) a fiber component comprising β-glucan; and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the composition further comprises an insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprising a viscous soluble fiber (such as a fermentable viscous soluble fiber); and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the berry fruit is blueberry. In some embodiments, the berry fruit is blackberry. In some embodiments, the composition further comprises an insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprising β-glucan; and c) a micronutrient component, wherein the micronutrient component comprises: 1) at least five vitamins, wherein at least one (such as at least two or three) of the vitamins is selected from the group consisting of β-carotene, MK7, and 5-methyl-tetrahydrofolate; 2) at least three minerals, and 3) at least one LCPUFA. In some embodiments, the berry fruit is blueberry. In some embodiments, the berry fruit is blackberry. In some embodiments, the composition further comprises an insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprising a viscous soluble fiber (such as a fermentable viscous soluble fiber); and c) a micronutrient component, wherein the micronutrient component comprises: 1) vitamins including vitamin A, vitamin B6, vitamin C, vitamin D, vitamin E, and vitamin K, 2) minerals including calcium, copper, iron, magnesium, manganese, selenium, and zinc, and 3) at least one omega-3 long chain polyunsaturated fatty acid (LCPUFA). In some embodiments, the composition further comprises an insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprising β-glucan; and c) a micronutrient component, wherein the micronutrient component comprises: 1) vitamins including vitamin A, vitamin B6, vitamin C, vitamin D, vitamin E, and vitamin K, 2) minerals including calcium, copper, iron, magnesium, manganese, selenium, and zinc, and 3) at least one omega-3 long chain polyunsaturated fatty acid (LCPUFA). In some embodiments, the composition further comprises an insoluble fiber. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component a fiber component comprising a viscous soluble fiber (such as a fermentable viscous soluble fiber); and c) a micronutrient component, wherein the micronutrient component comprises: 1) at least five (such as at least any of 6, 7, 8, 9, 10, 11, 12, 13, 14, 15, or 16) vitamins selected from the group consisting of vitamins in Table 1; 2) at least three (such as at least any of 4, 5, 6, 7, or 8) minerals, and 3) at least one LCPUFA (such as DHA). In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprises β-glucan; and c) a micronutrient component, wherein the micronutrient component comprises: 1) at least five (such as at least any of 6, 7, 8, 9, 10, 11, 12, 13, 14, 15, or 16) vitamins selected from the group consisting of vitamins in Table 1; 2) at least three (such as at least any of 4, 5, 6, 7, or 8) minerals, and 3) at least one LCPUFA (such as DHA). In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprising a viscous soluble fiber (such as a fermentable viscous soluble fiber); and c) a micronutrient component, wherein the micronutrient component comprises: 1) at least five (such as at least any of 6, 7, 8, 9, 10, 11, 12, 13, 14, 15, or 16) vitamins; 2) at least three (such as at least any of 4, 5, 6, 7, or 8) minerals selected from the group consisting of minerals in Table 2, and 3) at least one LCPUFA (such as DHA). In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprises β-glucan; and c) a micronutrient component, wherein the micronutrient component comprises: 1) at least five (such as at least any of 6, 7, 8, 9, 10, 11, 12, 13, 14, 15, or 16) vitamins; 2) at least three (such as at least any of 4, 5, 6, 7, or 8) minerals selected from the group consisting of minerals in Table 2, and 3) at least one LCPUFA (such as DHA). In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprising a viscous soluble fiber (such as a fermentable viscous soluble fiber); and c) a micronutrient component, wherein the micronutrient component comprises: 1) at least five (such as at least any of 6, 7, 8, 9, 10, 11, 12, 13, 14, 15, or 16) vitamins selected from the group consisting of vitamins in Table 1; 2) at least three (such as at least any of 4, 5, 6, 7, or 8) minerals selected from the group consisting of minerals in Table 2, and 3) at least one LCPUFA (such as DHA). In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

In some embodiments, the composition comprises: a) a fruit component comprising a concentrate from a berry fruit, wherein the fruit component comprises potassium; b) a fiber component comprising β-glucan; and c) a micronutrient component, wherein the micronutrient component comprises: 1) at least five (such as at least any of 6, 7, 8, 9, 10, 11, 12, 13, 14, 15, or 16) vitamins selected from the group consisting of vitamins in Table 1; 2) at least three (such as at least any of 4, 5, 6, 7, or 8) minerals selected from the group consisting of minerals in Table 2, and 3) at least one LCPUFA (such as DHA). In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate.

TABLE 1

| | | | |
|---|---|---|---|
| β-carotene | Vitamin K1 | Niacin | Biotin |
| Vitamin C | MK7 | Vitamin B6 | Pantothenic acid |
| Vitamin D3 | Thiamin | 5-Methyl-H₄- | Phosphatidyl |
| | | folate | choline |
| Vitamin E | Riboflavin | Vitamin B12 | |
| (mixed tocopherols) | | | |

TABLE 2

| | | |
|---|---|---|
| Calcium | Zinc | Potassium |
| Iron | Selenium | Chromium |
| Magnesium | Copper | |

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) all ingredients listed in Tables 1 and 2. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) all ingredients listed in Tables 1 and 2.

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 3. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 3.

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 4. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 4.

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 5. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 5.

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 6. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 6.

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Tables 9 and 10. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Tables 9 and 10.

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 11. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 11.

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 14. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 14.

In some embodiments, there is provided a nutritional composition comprising: a) a fruit component comprising a polyphenol (such as flavonoid, for example anthocyanidin); b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 15. In some embodiments, there is provided a nutritional composition comprising: a) a fruit component comprising a concentrate from a berry fruit; b) a fiber component comprising a viscous soluble fiber (such as fermentable viscous soluble fiber, for example β-glucan); and c) a micronutrient component, wherein the micronutrient composition comprises (including consisting of or consisting essentially of) at least 5 (such as at least 6, 7, 8, 9, 10, or all) micronutrients listed in Table 15.

In some embodiments, the micronutrient component further comprises iodine, phosphorous, molybdenum, chloride, boron, nickel, silicon, tin, and vanadium.

In some embodiments, the composition comprises: a) a fruit component comprising a concentrate from a berry fruit; b) a fiber component comprising a fermentable, viscous soluble fiber (such as β-glucan); and c) a micronutrient component comprising all ingredients listed in Tables 1 and 2. In some embodiments, the fruit component comprises potassium. In some embodiments, the composition (for example the micronutrient component of the composition) comprises at least one (such as at least any of 2, 3, 4, 5, 6, 7, 8) amino acids, for example at least one (such as at least any of 2, 3, 4, 5, 6, 7, 8) essential amino acids. In some embodiments, the composition comprises a protein (such as whey protein). In some embodiments, the composition further comprises chocolate (such as dark chocolate). In some embodiments, the LCPUFA is physically entrapped in the chocolate. In some embodiments, the fiber component further comprises a water insoluble fiber (such as wheat bran).

In some embodiments, the composition comprises all components listed in Table 3. In some embodiments, the DHA is physically entrapped in the dark chocolate. In some embodiments all lipid soluble micronutrients are entrapped in dark chocolate.

In some embodiments, the composition further comprises iodine, phosphorous, molybdenum, chloride, boron, nickel, silicon, tin, and vanadium. These ingredients can be present in any of the fruit component, the fiber component, and the micronutrient component. In some embodiments, the composition comprises manganese.

TABLE 3

| | | | | |
|---|---|---|---|---|
| β-carotene | Vitamin B12 | Calcium | Blueberries | Dark chocolate |
| Vitamin C | Biotin | Iron | Red grapes | Walnut |
| Vitamin D3 | Pantothenic | Magnesium | Dried plums | DHA |
| | acid | | | |
| Vitamin E | Chromium | Zinc | Cranberries | Glutamine |
| Vitamin K | Phosphatidyl | Selenium | | Whey protein |
| | choline | | | |
| MK7 | Niacin | Copper | β-glucan | |
| Thiamin | Vitamin B6 | Manganese | Wheat bran | |
| Riboflavin | 5-Methyl- | Potassium | | |
| | H₄-folate | | | |

In some embodiments, there is provided a nutritional composition, wherein the composition comprises all ingredients listed in Table 4. In some embodiments, the composition comprises all ingredients in Table 4 in the specified amounts.

TABLE 4

| | Per 2 Nutrition Bars | | |
|---|---|---|---|
| | (weight of 2 bars = 60 g; A = added; M = measured) | | |
| | % RDA or AI (calculated based on | | |
| | the measured values when available, | | |
| | and based on adult male RDA | | |
| Ingredients | unless indicated otherwise) | Grams or Units in 2 bars | Weight % in 2 Bars |
| Vitamin A | | 320 μg β-carotene (1,056 IU, 26 | 0.00053% β-carotene; |
| | | μg RAEs) (A) ≅1,600 IU OR | 0.000043% RAEs (A) OR |
| | | 40 μg RAEs β-carotene (cis + | 0.000067% RAEs (M) |
| | | trans) (M) | |
| C | 185% | 200 mg (A) OR 167 mg (M) | 0.33% (A) OR 0.28% (M) |
| D | 200% (as D3) | 400 IU = 10 μg (A) | 0.000017% |
| | | (1 IU = 0.025 (μg D3) | |
| E | ≅50% (α- | 10 mg (mixed tocopherols - ≅70% | 0.017% mixed tocopherols; |
| | tocopherol) | α-tocopherol assumed)(≅15 IU) (A) | 0.012% α-tocopherol (A) |
| K | 42% (K1) + MK7 | 50 μg K1 + 50 μg MK7 (A) | 0.0001% K1 + 0.0001% MK7 |
| Thiamin | ≅100% | 0.8 mg (A) OR ≅1.2 mg (M) | 0.0013% (A) OR 0.0020% (M) |
| | (estimated) | | |
| Riboflavin | 100% | 1.2 mg (A) OR 1.2 mg (M) | 0.0020% (A, M) |
| Niacin | 100% | 15 mg (A) OR ≅16 mg (M) | 0.025% (A) OR 0.027% (M) |
| B6 | 100% | 1.3 mg (A) OR ≅1.3 mg (M) | 0.0022% (A) |
| | | | 0.0022% (M) |
| 5-Methyl-H₄-folate | 100% | 400 μg THF (A) OR 440 μg (M) | 0.00067% THF (A) OR |
| | | | 0.00073% folate (M) |
| B12 | 66% | 1.6 μg (A) | 0.0000027% (A) |
| Biotin | 50% | 15 μg (A) | 0.000025% (A) |
| Pantothenic acid | 65% | 2.5 mg (A) OR 3.3 mg (M) | 0.0042% (A) OR 0.0055% (M) |
| Calcium | 50% | 550 mg (A) OR 500 mg (M) | 0.92% (A) OR 0.83% (M) |
| Iron | 50% (M); | 4 mg (as EDTA chelate) (A) | 0.0067% (A) OR 0.0073% (M) |
| | 12% (F) | OR 4.4 mg (M) | |
| Magnesium | 100% | 300 mg (A) OR 380 mg (M) | 0.50% (A) OR 0.63% (M) |
| Zinc | 43% | 4.75 mg (A) OR 4.75 mg (M) | 0.0079% (A, M) |
| Selenium | 20% | 11 μg (A) | 0.000018% (A) |
| Copper | 62% | 180 μg (A) OR 560 μg (M) | 0.00030% (A) OR |
| | | | 0.00093 (M) |
| Manganese | 120% | 2.8 mg (M) | 0.0047% (M) |
| Chromium | 22% | 32 μg (A) OR 7.7 μg (M) | 0.000053% (A) OR |
| | | | 0.000013% (M) |
| Potassium | 8.5% | ≅400 mg (M) | 0.67% (M) |
| DHA | | 400 mg DHA (A) | 0.67% (A) |
| Choline | 45% | 248 mg | 0.41% (A)? |
| Glutamine | | 2 g (A) | 3.3% (A) |
| Whey protein isolate | | 5 g (A) | 8.3% (A) |
| Soluble fiber: | | 4 g (A) | 6.7% (A) |
| Beta-glucan | | | |
| Insoluble fiber: | | 8 g (A) | 13% (A) |
| wheat bran | | | |

In some embodiments, there is provided a nutritional composition, wherein the composition comprises all ingredients listed in Table 5. In some embodiments, the composition comprises all ingredients in Table 5 in the specified amounts. In some embodiments, there is provided a nutritional composition, wherein the composition comprises all ingredients listed in Table 6. In some embodiments, the composition comprises all ingredients in Table 6 in the specified amounts. In some embodiments, there is provided a nutritional composition, wherein the composition comprises all ingredients listed in Tables 9 and 10. In some embodiments, the composition comprises all ingredients in Tables 9 and 10 in the specified amounts. In some embodiments, there is provided a nutritional composition, wherein the composition comprises all ingredients listed in Table 11. In some embodiments, the composition comprises all ingredients in Table 11 in the specified amounts. In some embodiments, there is provided a nutritional composition, wherein the composition comprises all ingredients listed in Table 14. In some embodiments, the composition comprises all ingredients in Table 14 in the specified amounts. In some embodiments, there is provided a nutritional composition, wherein the composition comprises all ingredients listed in Table 15. In some embodiments, the composition comprises all ingredients in Table 15 in the specified amounts. In some embodiments, there is provided a nutritional composition, wherein the composition comprises all ingredients from any one of Table 3, Table 4, Table 5, Table 6, Table 9, Table 10, Table 11, Table 14, or Table 15. In some embodiments, there is provided a nutritional composition, wherein the composition comprises all ingredients from any one of Table 3, Table, 4, Table 5, Table 6, Table 9, Table 10, Table 11, Table 14, or Table 15 in the specified amounts.

In some embodiments, the composition is less than about 200 kcal, such as less than about 150 kcal or less than about 100 kcal per unit composition (such as a nutrition bar). In some embodiments, the composition is about 5 kcal, such as less than about 4 kcal, less than about 3 kcal, less than about 2 kcal, per gram of the composition. In some embodiments, at least about 90%, including for example at least about 95%, 96%, 97%, 98%, 99%, or 100% of the ingredients in the composition are natural. In some embodiments, the composition is substantially free of artificial sweetener (such as sugar and honey). In some embodiments, the composition has an inner core that is substantially free of natural sweetener such as sugar and honey. In some embodiments, the composition is a nutrition bar that is coated with a sugar coating. The inner core of the nutrition bar can be substantially free of natural sweetener or can comprise additional sweetener.

In some embodiments, the combination of the fruit component and the fiber component represent at least about 90%, including for example at least about 95%, 98%, 99%, or 100% total carbohydrates in the composition.

In some embodiments, the weight ratio of the fruit component and the fiber component in the composition is about 10:1 to about 1:10, including for example about 5:1 to about 1:5, about 3:1 to about 1:3, about 2:1 to about 1:2, or about 1:1.

In some embodiments, the combination of the fruit component and the fiber component represent at least about 90%, including for example at least about 95%, 98%, 99%, or 100% total calorie value in the composition. In some embodiments, the composition further comprises an additional macronutrient, including, but are not limited to, fat. In some embodiments, the composition comprises no more than about 5% (including for example no more than about 4%, 3%, 2%, or less) a macronutrient (such as fat).

In some embodiments, the water activity of the composition is more than about any of 0.5, 0.6, 0.7, 0.8, or 0.9. In some embodiments, the water activity of the composition is less than about any of 0.7, 0.6, 0.5, 0.4, or 0.3. In some embodiments, the water activity of the composition is about 0.3 to about 0.9, including for example about 0.5 to about 0.8, or about 0.6 to about 0.7. In some embodiments, the composition is stable against oxidation for at least 1, 2, 3, 4, or 5 days when exposed to the air. In some embodiments, the composition is stable against oxidation for at least 1, 2, 3, 4, 5, 6, 7, 8, 9, 10, 11, 12, 24, or 36 months when stored in a vacuum sealed package.

The fruit component, fiber component, and micronutrient component are further discussed below in more detail.

In some embodiments, the composition further comprises a ground coffee. In some embodiments, the coffee component is at least about 0.5%, 1%, 2%, 3%, 4% or 5% (w/w) of the composition, including any percentages in between these values. In some embodiments, the composition is coated in ground coffee. In some embodiments, the ground coffee comprises ground espresso beans. The coffee can be ground to different particle sizes to affect final product properties and provides flavor in addition to serving as a source of additional polyphenols and fiber.

### The Fruit Component

The nutritional compositions described herein comprise a fruit component. In some embodiments, the fruit component comprises a polyphenol. In some embodiments, the fruit component comprises flavonoid, including, but not limited to, anthocyanidin, flavanol, flavanone, flavone, and flavonole. In some embodiments, the fruit component comprises anthocyanidin. The flavonoid (such as anthocyanidin) can be provided, for example, from the concentrate of a fruit comprising flavonoid (such as anthocyanidin). The fruit component thus in some embodiments comprises a concentrate from a fruit comprising flavonoid (such as anthocyanidin). In some embodiments, the fruit component comprises stilbenes, such as pterostilbene or resveratrol. In some embodiments, the fruit component comprises a phenolic compound such as quercetin. In some embodiments, the fruit comprising flavonoid comprises at least about 10 mg (including at least about any of 20 mg, 30 mg or 40 mg) flavonoid per 100 grams of edible portion of the fruit. In some embodiments, the fruit component comprises concentrates from at least two (such as at least any of 3, 4, 5, 6, or more) fruits comprising polyphenols (such as flavonoid).

Exemplary fruits comprising anthocyanidin include, but are not limited to, berry fruits. Berry fruits include, but are not limited to, blueberries, raspberries, mulberries, strawberries, blackberries, grapes, elderberries, and cranberries. In some embodiments, the fruit component comprises concentrates from at least two, three, four, five, six, or more berry fruits. In some embodiments, the fruit component consists of or consists essentially of concentrates from berry fruits. In some embodiments, the fruit component comprises (including consisting of or consisting essentially of) concentrates from blueberries. In some embodiments, the fruit component comprises (including consisting of or consisting essentially of) concentrates from blackberries. In some embodiments, the fruit component comprises (including consisting of or consisting essentially of) concentrates from cranberries. In some embodiments, the fruit component comprises (including consisting of or consisting essentially of) concentrates from blueberries, blackberries, cranberries, mulberries, and/or grapes. In some embodiments, the fruit component is freeze-dried from a fruit. In some embodiments, the fruit component is drum-dried from a fruit. In some embodiments, the fruit component is spray dried from a fruit. In some embodiments the fruit component is air dried from a fruit.

We have surprisingly found that the incorporation of a dried fruit component is not only important for achieving the nutritional benefits of this product, but also important for obtaining a sensorially acceptable final product. The dried fruit component masks off flavors associated with macronutrients and results in an optimal final product texture.

In some embodiments, the fruit component comprises at least about 10% (including for example at least about any of 20%, 30%, 40%, 50%, 60%, 70%, 80%, 90%, or 95%) of concentrate from a fruit comprising polyphenol (such as a flavonoid, for example, anthocyanidin). In some embodiments, the fruit component comprise at least about 10% (including for example at least about any of 20%, 30%, 40%, 50%, 60%, 70%, 80%, 90%, or 95%) of concentrate from a berry fruit.

In some embodiments, the fruit component further comprises concentrate from a fruit other than a berry fruit. For example, in some embodiments, the fruit component further comprises concentrate from dates, figs, papayas, apricots, peaches, pineapples, bananas, cherries, prunes, oranges, and/or apples. In some embodiments, the fruit component comprises (including consisting of or consisting essentially of) concentrates from blueberries, red grapes, dried plums, and cranberries.

In some embodiments, the fruit component in the composition comprises monomeric flavonoid. The monomeric flavonoid can be provided, for example, from the concentrate of a fruit comprising monomeric flavonoid. The fruit component thus in some embodiments comprises a concentrate from a fruit comprising monomeric flavonoid. In some embodiments, the fruit comprising monomeric flavonoid comprises at least about 10 mg (including for example at least about 20 mg, 30 mg, 40 mg, or 50 mg) monomeric flavonoid per 100 grams of edible portion of the fruit. In some embodiments, the fruit component comprises concentrates from at least two (such as at least any of 3, 4, 5, 6, or more) fruits comprising monomeric flavonoid.

In some embodiments, the fruit component comprises at least about 10% (including for example at least about any of 20%, 30%, 40%, 50%, 60%, 70%, 80%, 90%, or 95%) of concentrate from a fruit comprising monomeric flavonoid. Fruit comprising monomeric flavonoid include, but are not limited to, grapes, cranberries, blueberries, and elderberries. In some embodiments, the fruit component comprises at least about 1 g, 2 g, 3 g, 4 g, 5 g, 6 g, 7 g, 8 g, 9 g, or 10 g of blueberries, including any amounts in between these values.

In some embodiments, the fruit component comprises potassium. In some embodiments, the nutritional composition provides a daily value of about 100 to 500 milligrams (including for example about 100 to about 200, about 200 to about 300, about 300 to about 400, about 400 to about 500 mg, about 500 to about 600, about 600 to about 700 mg, about 700 mg to about 1000 mg, about 1000 mg to about 1500 mg, about 1500 mg to about 2000 mg) of potassium. In some embodiments, the fruit component is the only source of potassium in the nutritional composition. In some embodiments, the fruit component of the nutritional composition provides at least about 90%, including for example at least about 95%, 98%, 99%, or 100% of all the potassium in the nutritional composition. The potassium in the fruit component can be provided, for example, from the concentrate of a fruit comprising high potassium. These include, for example, banana, kiwi, apple, apricot, and raisins. In some embodiments, the composition comprises potassium in the amount of about 1% to about 20%, including for example about 1% to about 5%, about 5% to about 10%, about 10% to about 15%, about 15% to about 20%, such as about 10% RDA. In some embodiments, the composition comprises about 100 to about 500 mg, including for example about 100 to about 200 mg, about 200 to about 300 mg, about 300 to about 400 mg, about 400 to about 500 mg, such as about 400 mg potassium. In some embodiments, the composition comprises about 0.2% to about 1%, including for example about 0.2% to about 0.3%, about 0.3% to about 0.4%, about 0.4% to about 0.5%, about 0.5% to about 0.6%, about 0.6% to about 0.7%, about 0.7% to about 0.8%, about 0.8% to about 0.9%, or about 0.9% to about 1% potassium.

The fruit component in the nutritional composition in some embodiments comprises soluble fiber or insoluble fiber. In some embodiments, the total dietary fiber content of the fruit component is about any of 1, 2, 3, 4, 5, 6, 7, 8, 9, or 10 grams per 100 grams of the fruit component. It is understood that such soluble fiber is in addition to and different from the soluble and insoluble fibers in the fiber component, which is further described herein.

In some embodiments, the nutritional composition is a solid nutritional composition. In some embodiments, the nutritional composition is a liquid nutritional composition. In some embodiments, the composition comprises about 1% to 20%, including for example about 1% to about 5%, about 5% to about 10%, about 10% to about 15%, or about 15% to about 20% of the fruit component by weight of the nutritional composition. In some embodiments, the composition comprises at least about 5%, including for example at least about any of 10%, 15%, 20%, 30%, 40%, or 50% of the fruit component by weight of the nutritional composition.

In some embodiments, the fruit component provides a total phenolic content of at least 5 mg, such as at least about any of 10 mg, 15 mg, 20 mg, or 30 mg, as determined by mg of gallic acid equivalents per gram of fruit component.

In some embodiments, the fruit component in the nutritional composition provides about 10% to about 80% (including for example about 10% to about 20%, about 20% to about 30%, about 30% to about 40%, about 40% to about 50%, about 50% to about 60%, about 60% to about 70%, about 70% to about 80%) of the total carbohydrates of the nutritional composition.

In some embodiments, the fruit component in the nutritional composition provides about 10% to about 80% (including for example about 10% to about 20%, about 20% to about 30%, about 30% to about 40%, about 40% to about 50%, about 50% to about 60%, about 60% to about 70%, about 70% to about 80%) of the total calorie of the nutritional composition.

The nutritional composition of the present invention in some embodiments comprises sufficient fruit component to provide an individual with from about 1 g to about 100 g, including for example from about 1 g to about 10 g, about 10 g to about 20 g, about 20 g to about 30 g, about 30 g to about 40 g, about 40 g to about 50 g, about 50 g to about 60 g, about 60 g to about 70 g, about 70 g to about 80 g, per day of fruit component. The total amount of the fruit component in some embodiments is contained in multiple individual product forms, for example, two nutritional bars per day.

### The Fiber Component

The nutritional compositions described herein comprise a fiber component comprising a viscous soluble fiber. The viscous soluble fiber described herein is separate from any similar fiber component that is inherently part of the fruit component.

In some embodiments, the nutritional compositions described herein comprise a fiber component comprising a fermentable viscous soluble fiber. The fermentable viscous soluble fiber described herein is separate from any similar fiber component that is inherently part of the fruit component. We have surprisingly found that a fermentable viscous soluble fiber, for example, β-glucan, is essential for the function of the nutritional composition. Specifically, a composition comprising a fruit component, a fiber component comprising the fermentable viscous soluble fiber, and a micronutrient component is effective in raising HDL when administered into a healthy human individual. By contrast, in some of the studies described herein, a composition not having the fermentable viscous soluble fiber was ineffective in raising HDL. Moreover, substituting the fermentable viscous soluble fiber with a non-fermentable viscous soluble fiber or a fermentable non-viscous soluble fiber (such as inulin) eliminated the effect of the nutritional composition. Based on these observations, it is hypothesized that fermentable viscous soluble fiber plays an important role in the compositions described herein. The fermentable viscous soluble fiber is converted to organic acids (short chain fatty acids and lactic acids) that support gut health. Meanwhile the fermentable viscous soluble fiber serves as a physical barrier between the luminal contents of the gut and the apical surface of the gut wall.

In some embodiments, the nutritional compositions described herein comprise a fiber component comprising a non-fermentable viscous soluble fiber. The non-fermentable viscous soluble fiber described herein is separate from any similar fiber component that is inherently part of the fruit component. While, as described above, a composition in which some of the fermentable viscous soluble fiber was substituted with a nonfermentable viscous soluble fiber (for example, hydroxypropyl methylcellulose (HPMC)), HDL was not significantly raised until 8-weeks. However, this mixed formulation proved to posses other benefits, including significantly lowering LDL-c at both 2-weeks and 8-weeks, and improving insulin resistance significantly at 8-weeks, which the bar only containing the viscous soluble fiber did not.

In some embodiments, the compositions described herein thus require a viscous soluble fiber (such as a fermentable viscous soluble fiber). Viscosity of dietary fibers can be measured, for example, by applying a shear stress to an aqueous solution of known concentration and is reported in SI physical unit of dynamic viscosity in “Pascal-seconds.” A fluid with a viscosity of one Pascal-second, if placed between two plates, would upon one of the plates being pushed sideways with a shear stress of one Pascal, move a distance equal to the thickness of the layer between the two plates in one second.

The viscosity of dietary fibers varies by more than an order of magnitude. Low viscosity dietary fibers prepared as a 0.5% solution in water and conducted at 20° C. with a shear rate of 12.9 sec-1, exhibit dynamic viscosity values of 30 milli Pascals-second (mpA-sec), whereas high viscosity fibers exhibit values on the order to >500 mPa-sec. The high viscosity imparted by this type of soluble fiber slows the rate at which nutrients are absorbed. By slowing the passage of nutrients from the gut to the blood, plasma glucose levels are slower to rise, placing less workload on the pancreas and limiting the associated adverse consequences.

The nutritional composition in some embodiments comprises at least about 2%, including at least about any of 3%, 4%, 5%, 6%, 7%, 8%, 9%, or 10% (w/w) viscous soluble fiber (such as a fermentable viscous soluble fiber). In some embodiments, at least about 10%, including at least about any of 20%, 30%, 40%, 50% of the total soluble fiber in the nutritional composition is viscous soluble fiber (such as a fermentable viscous soluble fiber). In some embodiments, at least about 10%, including at least about any of 20%, 30%, 40%, 50% of the total fiber in the nutritional composition is viscous soluble fiber (such as a fermentable viscous soluble fiber).

In some embodiments, the fiber component comprises only fermentable viscous soluble fiber, that is, all soluble fibers in the fiber component (i.e., soluble fiber other than those that inherently exist in the fruit component) are fermentable and viscous. In some embodiments, the fiber component comprises a mixture of fermentable and non-fermentable viscous soluble fiber.

Fermentable viscous soluble fiber can be provided, for example, by including fermentable viscous soluble fiber-containing product in the composition, such as konjac flour. In some embodiments, the fermentable viscous soluble fiber is added directly into the composition. In some embodiments, the amount of the fermentable viscous soluble fiber added to the composition is about 1% to about 30%, including for example about 1% to about 5%, about 5% to about 10%, about 10% to about 15%, about 15% to about 20%, about 20% to about 30%, or about 15% of recommended daily intake values for soluble fiber.

Non-fermentable viscous soluble fiber can be provided, for example, by including non-fermentable viscous soluble fiber-containing product in the composition, such as HPMC. In some embodiments, the non-fermentable viscous soluble fiber is added directly into the composition. In some embodiments, the amount of the non-fermentable viscous soluble fiber added to the composition is about 1% to about 30%, including for example about 1% to about 5%, about 5% to about 10%, about 10% to about 15%, about 15% to about 20%, about 20% to about 30%, or about 15% of recommended daily intake values for soluble fiber.

In some embodiments, the viscous soluble fiber (such as fermentable viscous soluble fiber) has a viscosity of more than about 100 mPa-sec. In some embodiments, the viscous soluble fiber (such as fermentable viscous soluble fiber) has a viscosity of at least about any of 100, 200, 300, 400, or 500 mPa-sec. In some embodiments, the viscous soluble fiber (such as fermentable viscous soluble fiber) is naturally occurring. In some embodiments, the viscous soluble fiber (such as fermentable viscous soluble fiber) is palatable. In some embodiments, the viscous soluble fiber (such as fermentable viscous soluble fiber) is immunomodulating.

In some embodiments, the fermentable viscous soluble fiber is β-glucan. In some embodiments, the fermentable viscous soluble fiber is selected from the group consisting of: pectin, galacto-oligosaccharide, guar gum, acacia gum, locust bean gum, psyllium, hemicellulose, konjac mannan, galacto mannan, aloe vera, carrageenan. In some embodiments, the fiber component comprises at least two, three, four, or five different fermentable viscous soluble fibers.

In some embodiments, the non-fermentable viscous soluble fiber is HPMC. In some embodiments, the non-fermentable viscous soluble fiber is methylcellulose.

In some embodiments, the composition comprises about 5% to about 50%, including for example about 10% to about 20%, such as about 15% recommended daily value of soluble fiber. In some embodiments, the composition comprises about 1 gram to about 5 grams (such as about 4 grams) of the soluble fiber. In some embodiments, the composition comprises about 5% to about 10% soluble fiber, including for example about 6% to about 7% soluble fiber.

The fiber component of the nutritional composition can further comprise non-viscous soluble fiber. In some embodiments, the non-viscous fiber is a fermentable non-viscous soluble fiber. In some embodiments, the fermentable non-viscous soluble fiber is inulin. In some embodiments, one or more fermentable non-viscous soluble fiber(s) is selected from the group consisting of short chain fructooligosaccharide (scFOS), fructooligosaccharie (FOS), xylooligosaccharide, galactooligosaccharides, mannan oligosaccharides, polydextrose, raffinose, stachyose, verbascose, and one or more resistant starches.

The fiber component of the nutritional composition can further comprise water insoluble fiber. Suitable water insoluble fibers include, but are not limited to, oat hull fiber, pea hull fiber, soy hull fiber, soy cotyledon fiber, sugar beet fiber, cellulose, corn bran, wheat bran, rice bran, oat bran, or combinations thereof. In some embodiments, the insoluble fiber is selected from the group consisting of lignin and hemicellulose. A diet high in insoluble fiber decreases transit time of luminal contents through the GI tract, potentially minimizing opportunities for pathogenic bacteria to adhere to, colonize, and invade the gut lining and cause systemic inflammation. The insoluble fiber can be milled to different particle sizes to optimize nutritional benefits and sensorial acceptability of final products.

Thus, the nutritional composition in some embodiments comprises at least about 2%, including at least about any of 3%, 4%, 5%, 6%, 7%, 8%, 9%, or 10% (w/w) insoluble fiber. In some embodiments, at least about 10%, including at least about any of 20%, 30%, 40%, 50% of the total soluble fiber in the nutritional composition is insoluble fiber. In some embodiments, at least about 10%, including at least about any of 20%, 30%, 40%, 50% of the total fiber in the nutritional composition is insoluble fiber.

In some embodiments, the composition comprises about 10% to about 50%, including for example about 20% to about 40%, such as about 30% recommended daily value of insoluble fiber. In some embodiments, the composition comprises about 1 gram to about 10 grams (such as about 8 grams) of the insoluble fiber. In some embodiments, the composition comprises about 10% to about 20% soluble fiber, including for example about 13% insoluble fiber.

In some embodiments, the fiber component comprises wheat bran, which also provides manganese in addition to insoluble fiber. Wheat bran can be present in the composition in an amount of about 5% to about 20%, including for example about 10% to about 15%, for example about 13%. In some embodiments, the composition comprises manganese in the amount of about 50% to about 200%, including for example about 100% to about 150%, such as about 120% RDA. In some embodiments, the composition comprises about 1 to about 5 mg, including for example about 2 mg to about 3 mg manganese. In some embodiments, the composition comprises about 0.0025% to about 0.01%, including for example about 0.004% to about 0.005% manganese.

In some embodiments, the nutritional composition is a solid nutritional composition. In some embodiments, the nutritional composition is a liquid composition. In some embodiments, the nutritional composition comprises about 1% to 20%, including for example, about 1% to about 5%, about 5% to about 10%, about 10% to about 15%, or about 15% to about 20% of the fiber component by weight of the nutritional composition.

In some embodiments, the fiber component in the nutritional composition provides about 10% to about 80% (including for example about 10% to about 20%, about 20% to about 30%, about 30% to about 40%, about 40% to about 50%, about 50% to about 60%, about 60% to about 70%, about 70% to about 80%) of the total carbohydrates of the nutritional composition.

In some embodiments, the fiber component in the nutritional composition provides about 10% to about 80% (including for example about 10% to about 20%, about 20% to about 30%, about 30% to about 40%, about 40% to about 50%, about 50% to about 60%, about 60% to about 70%, about 70% to about 80%) of the total calories of the nutritional composition.

In some embodiments, the nutritional composition is free or substantially free of wheat and/or gluten. In some embodiments, the fiber component in the nutritional composition is free or substantially free of wheat and/or gluten. In some embodiments, the fiber component in the nutritional composition comprises gluten-free β-glucan. In some embodiments, the fiber component in the nutritional composition comprises fiber from one or more sources selected from the group consisting of corn, potatoes, rice, tapioca, amaranth, arrowroot, millet, montina, lupin, quinoa, sorghum (jowar), taro, teff, chia seed, yam, bean, soybean, buckwheat, and gram flour (e.g., derived from chickpeas).

### Micronutrient Components

The compositions described herein comprise a micronutrient component. The micronutrient component described herein refers to micronutrients that are added in addition to those inherently present in the fruit component or the fiber component.

In some embodiments, the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, and 5) at least one (such as at least about 2, 3, 4, 5, 6) micronutrient that improves gut health. In some embodiments, the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, 5) at least one (such as at least about 2, 3, 4, 5, 6) micronutrient that improves gut health, and 6) at least one (such as at least about 2, 3, 4, 5, 6) micronutrients that improves maintenance of DNA integrity. In some embodiments, the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, 5) at least one (such as at least about 2, 3, 4, 5, 6) micronutrient that improves gut health, and 6) at least one (such as at least about 2, 3, 4, 5, 6) micronutrient that improves lipid metabolism. In some embodiments, the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, 5) at least one (such as at least about 2, 3, 4, 5, 6) micronutrient that improves gut health, and 6) at least one (such as at least about 2, 3, 4, 5, 6) micronutrient that improves satiety. In some embodiments, the micronutrient component comprises 1) at least one (such as at least 2, 3, 4, 5, or 6) micronutrient that improves mitochondrial health in an individual; 2) at least one (such as at least about 2, 3, 4, 5, 6) micronutrient that reduces inflammation in an individual; 3) at least one (such as at least about 2, 3, 4, 5, 6) micronutrient that improves immune status in an individual, 4) at least one (such as at least about 2, 3, 4, 5, 6) micronutrient that improves the redox status or antioxidant defense mechanism, 5) at least one (such as at least about 2, 3, 4, 5, 6) micronutrient that improves gut health, 6) at least one (such as at least about 2, 3, 4, 5, 6) micronutrient that improves lipid metabolism, 7) at least one (such as at least about 2, 3, 4, 5, 6) micronutrient that improves satiety, and 8) at least one (such as at least about 2, 3, 4, 5, 6) micronutrients that improves maintenance of DNA integrity. In some embodiments, the micronutrient component further comprises at least one (such as at least about 2, 3, 4, 5, 6) micronutrient that improves vascular function and blood pressure.

Micronutrients that improve mitochondrial health include, but are not limited to, choline, calcium, folate, vitamin B6, vitamin B12, niacin, panthotenic acid, vitamin D, LCPUFA, glutamine, polyphenolics (such as plant-derived polyphenol) magnesium, zinc, copper, and iron. The effect of micronutrients on mitochondrial health can be evaluated by measuring the levels of biomarkers, such as REE, fasting insulin/glucose, leukocyte proliferation, and mitochondrial damage.

Micronutrients that reduce inflammation in an individual include, but are not limited to, plant-derived polyphenols, vitamin D, LCPUFA, magnesium, and zinc. The effect of micronutrients on inflammation reduction can be evaluated by measuring the levels of biomarkers, such as lipids and lipoproteins, Hcy, GSH, leukocyte proliferation capacity, CCR9, Hs-CRP, serum IgA, and pro-inflammatory cytokines.

Micronutrients that improve vascular function and blood pressure in an individual include, but are not limited to vitamin D, LCPUFA, calcium, magnesium, potassium, and zinc. The effect of micronutrients on vascular health and blood pressure reduction can be evaluated by measuring the clinical blood pressure, non-invasive assessment of vascular elasticity and levels of biomarkers, such as lipids, and specific lipoprotein subspecies and biomarkers for endothelial function.

Micronutrients that improve the immune status of an individual include, but are not limited to, choline, calcium, zinc, panthotenic acid, vitamin D, LCPUFA, glutamine, and polyphenolics. The effect of micronutrients on immune status can be evaluated by measuring the levels of biomarkers, such as leukocyte proliferation capacity, Hs-CRP, lipids and lipoproteins, proinflammatory cytokines, and CCR9.

Micronutrients that improve redox status or antioxidant defense mechanisms include, but are not limited to, choline, folate, vitamin B6, vitamin B12, vitamin C, vitamin E, niacin, LCPUFA, glutamine, and plant-derived polyphenols. The effect of micronutrients on redox status or antioxidant defense mechanisms can be evaluated by measuring the levels of biomarkers, such as total lipids and lipoproteins Hcy, cysteine/CySS ratio, GSH/GSSG ratio, Cysgly, vitamin C, urate, and vitamin E.

Micronutrients that improve gut health include, but are not limited to, choline, calcium, LCPUFA, glutamine, plant-derived polyphenols, and magnesium. The effect of micronutrients on gut health can be evaluated by measuring the levels of biomarkers, such as apolipoproteins, CCR9, Hs-CRP, proinflammatory cytokines, GI-motility, gut flora profile, and plasma endotoxin.

Micronutrients that improve maintenance of DNA integrity include, but are not limited to, folate (such as methyl-tetrahydrofolate), biotin, zinc, iron, selenium, magnesium, and vitamin K.

Micronutrients that improve lipid metabolism include, but are not limited to, omega-3 long chain polyunsaturated fatty acids, polyphenols (such as flavonoids), and soluble fiber, and can be evaluated by measuring the levels of lipids, lipoproteins and apolipoproteins as well as lipoprotein phenotypes, blood pressure and vascular function studies.

Micronutrients that improve satiety include, but are not limited to, essential amino acids, essential fatty acids, soluble and insoluble fiber, and can be evaluated by measuring the levels of orexigenic and anorexigenic peptides.

It is understood that a single micronutrient may be able to perform two or more functions described above.

In some embodiments, the micronutrient component comprises: 1) at least five vitamins, 2) at least three minerals, and 3) at least one omega-3 long chain polyunsaturated fatty acid (LCPUFA), and 4) at least one amino acid. In some embodiments, the micronutrient component comprises: 1) at least five vitamins, wherein at least one of the vitamins is a vitamin B; 2) at least three minerals, and 3) at least one LCPUFA. In some embodiments, the micronutrient component comprises: 1) at least five vitamins, wherein at least one of the vitamins is vitamin K (such as MK7); 2) at least three minerals, and 3) at least one LCPUFA. In some embodiments, the micronutrient component comprises: 1) at least five vitamins, wherein at least one of the vitamins is a vitamin B and at least one of the vitamins is vitamin K; 2) at least three minerals, and 3) at least one LCPUFA.

In some embodiments, the micronutrient component comprises: 1) at least five vitamins selected from the group consisting of: vitamin A, vitamin B6, vitamin C, vitamin D, vitamin E, vitamin K, and folate, 2) at least three minerals selected from the group consisting of iron, magnesium, zinc, and calcium, and 3) at least one omega-3 long chain polyunsaturated fatty acid (LCPUFA).

In some embodiments, the micronutrient component comprises: 1) at least five vitamins selected from the group consisting of: vitamin A, vitamin B1, vitamin B2, vitamin B3, vitamin B5, vitamin B6, vitamin B12, vitamin C, vitamin D, vitamin E, and vitamin K, 2) at least three minerals selected from the group consisting of calcium, copper, iron, magnesium, manganese, selenium, and zinc, and 3) at least one omega-3 long chain polyunsaturated fatty acid (LCPUFA).

In some embodiments, the micronutrient component comprises: 1) vitamins including vitamin A, vitamin B1, vitamin B2, vitamin B5, vitamin B6, vitamin B12, vitamin C, vitamin E, and vitamin K, 2) minerals including calcium, copper, iron, magnesium, manganese, selenium, and zinc, and 3) at least one omega-3 long chain polyunsaturated fatty acid (LCPUFA).

In some embodiments, the micronutrient component comprises one or more micronutrients in a biologically active form. For example, in some embodiments, the micronutrient component comprises a folate (such as a reduced folate, for example 5-methyl-tetrahydrofolate). In some embodiments, the micronutrient component comprises β-carotene. In some embodiments, the micronutrient component comprises MK7. In some embodiments, the micronutrient component comprises both vitamin K1 and MK7. In some embodiments, the micronutrient component comprises β-carotene. In some embodiments, the micronutrient component comprises MK7. In some embodiments, the micronutrient component comprises 5-methyl-tetrahydrofolate. In some embodiments, the micronutrient component comprises at least two of β-carotene, MK7, and 5-methyl-tetrahydrofolate. In some embodiments, the micronutrient component comprises β-carotene, MK7, and 5-methyl-tetrahydrofolate.

Thus, for example, in some embodiments, the micronutrient component comprises: 1) at least five vitamins, wherein at least one of the vitamins is selected from the group consisting of β-carotene, MK7, and 5-methyl-tetrahydrofolate; 2) at least three minerals, and 3) at least one LCPUFA. In some embodiments, the micronutrient component comprises: 1) at least five vitamins, wherein at least two of the vitamins is selected from the group consisting of β-carotene, MK7, and 5-methyl-tetrahydrofolate; 2) at least three minerals, and 3) at least one LCPUFA. In some embodiments, the micronutrient component comprises: 1) at least five vitamins, comprising β-carotene, MK7, and 5-methyl-tetrahydrofolate; 2) at least three minerals, and 3) at least one LCPUFA.

In some embodiments, the micronutrient component comprises biotin. In some embodiments, the micronutrient component comprises chromium. In some embodiments, the micronutrient component comprises niacin. In some embodiments, the micronutrient component comprises thiamine. In some embodiments, the micronutrient component comprises phosphatidyl choline. In some embodiments, the micronutrient component comprises pantothenic acid.

In some embodiments, the micronutrient component comprises at least one (such as at least about 2, 3, 4, 5, 6, or 8) amino acid. In some embodiments, the micronutrient component comprises at least one (such as at least about 2, 3, 4, 5, 6, 7, or 8) essential amino acids.

In some embodiments, the micronutrient component comprises at least about 3 (including for example at least about any of 4, 5, 6, 7, 8, 9, 10, 11, 12, 13, 14, 15, or 16) micronutrients listed in Table 1. In some embodiments, the micronutrient component comprises all ingredients in Table 1.

In some embodiments, the micronutrient component comprises at least about 3 (including for example at least about any of 4, 5, 6, 7, or 8) micronutrients listed in Table 2. In some embodiments, the micronutrient component comprises all ingredients in Table 2.

In some embodiments, the micronutrient component comprises all ingredients listed in Tables 1 and 2.

In some embodiments, the micronutrient component comprises all vitamins and minerals listed in Table 3. In some embodiments, the micronutrient composition comprises all vitamins and minerals listed in Table 4. In some embodiments, the micronutrient composition comprises all vitamins and minerals listed in Table 4 at the specified amounts.

The amounts of the micronutrients may be designed to meet the RDA for each micronutrient. Alternatively, the amounts of the micronutrients in the composition may be designed to complement dietary intake of the micronutrients rather than to provide a composition that meets RDA for every micronutrients. Some micronutrients in the composition can therefore be present in an amount that is significantly below the RDA for the specific micronutrient. Instead, these micronutrients can be provided in an amount that is approximately at the Estimated Average requirement (EAR) level, which is two standard deviations below the RDA. This ensures no oversupplementing while vigorously responding to the need to correct widespread micronutrient deficiencies in populations unable to consume an optimal diet. Thus, for example, in some embodiments, the composition comprises one or more vitamin Bs, wherein the amount of the vitamin B in the composition is sufficient to provide at least about 100% RDA per day. In some embodiments, the composition comprises chromium, wherein the amount of the magnesium in the composition is sufficient to provide at least about 100% RDA per day.

The various micronutrients that can be included in the micronutrient component of the nutritional composition are further described herein in more detail.

### Vitamins

Vitamins described herein include, but are not limited to, vitamin A, vitamin B (vitamins B1, B2, B3, B5, B6, B12), vitamin C, vitamin D, vitamin E, vitamin K, folate, choline, magnesium, and biotin.

In some embodiments, the micronutrient component comprises vitamin A. In some embodiments, the composition comprises 40% RDA of vitamin A. The micronutrient component could in some embodiments comprise a provitamin A carotenoid, including beta-carotene. Provitamin A carotenoid can be converted in the body into retinol, which is an essential component of the light perception and vision pathways. Retinol is also a key component for a class of transcription factors important for cellular differentiation. In everyday developmental pathways, retinol is important for the differentiation of WBC and therefore immunity. Retinol also plays a role in RBC differentiation, as it is required for iron mobilization from storage sites to hemoglobin. The provitamin A carotenoid (such as (3-carotene) can be present in the composition at an amount that provides about 5% to about 40% RDA, including for example about 5% to about 10%, about 10% to about 20%, about 10% to about 30%, or about 30% to about 40% RDA. In some embodiments, the provitamin A carotenoid (such as β-carotene) is present in the composition at an amount of no more than about 60% RDA, including for example no more than about any of 50%, 40%, 30%, 20%, 10%, or 5% RDA.

In some embodiments, the total amount of the provitamin carotenoid (such as β-carotene) in the micronutrient component of the composition is about 160 to about 640 μg, including for example about 320 μg. In some embodiments, the weight percentage of the β-carotene in the composition is about 0.00025% to about 0.001%, including for example about 0.0005%. In some embodiments, the composition comprises about 1000, 1100, 1200, 1300, 1400, 1500, 1600, 1700, 1800, 1900, or 2000 IU RAE (Retinol Activity Equivalents). In some embodiments, the composition comprises about 0.00003% to about 0.00014%, including for example about 0.00006% to about 0.00007% RAE.

In some embodiments, the micronutrient component comprises thiamin. Thiamin is a water soluble B vitamin, also known as vitamin B1. In some embodiments, the composition comprises thiamin in the amount of about 50% to about 200%, including for example about 100% RDA. In some embodiments, the composition comprises about 0.5 to about 2 mg, including for example about 0.8 mg to about 1.2 mg thiamin. In some embodiments, the composition comprises about 0.0006% to about 0.004%, including for example about 0.001% to about 0.002% thiamin.

In some embodiments, the micronutrient component comprises riboflavin. Riboflavin is a water soluble B vitamin, also known as vitamin B2. In some embodiments, the composition comprises riboflavin in the amount of about 50% to about 200%, including for example about 100% RDA. In some embodiments, the composition comprises about 0.6 to about 2.4 mg, including for example about 1.2 mg riboflavin. In some embodiments, the composition comprises about 0.001% to about 0.004%, including for example about 0.002% riboflavin.

In some embodiments, the micronutrient component also comprises niacin. Niacin is a water-soluble vitamin, which is also known as nicotinic acid or vitamin B3. Nicotinamide is the derivative of niacin used by the body to form important coenzymes for energy metabolism, nicotinamide adenine dinucleotide (NAD) and nicotinamide adenine dinucleotide phosphate (NADP). In some embodiments, the composition comprises niacin in the amount of about 50% to about 200%, including for example about 100% RDA. In some embodiments, the composition comprises about 7.5 to about 30 mg, including for example about 15 to 16 mg niacin. In some embodiments, the composition comprises about 0.01% to about 0.05%, including for example about 0.02% to about 0.03% niacin.

In some embodiments, the micronutrient component comprises pantothenic acid. Pantothenic acid, also called vitamin B5, is a component of coenzyme A (CoA), an essential coenzyme in a variety of reactions that sustain life. In some embodiments, the composition comprises pantothenic acid in the amount of about 25% to about 200%, including for example about 50% to about 75%, or about 65% RDA. In some embodiments, the composition comprises about 1 to about 5 mg, including for example about 2.5 mg to about 3.3 mg pantothenic acid. In some embodiments, the composition comprises about 0.002% to about 0.01%, including for example about 0.004% to about 0.006% pantothenic acid.

In some embodiments, the micronutrient component further comprises vitamin B6. Vitamin B6 is a water soluble vitamin that was first isolated in 1930's. There are six forms of vitamin B6: pyridoxal, pyridoxine, pyridoxamine, and their active phosphate derivatives including pyridoxal 5′-phosphate (PLP) and pridoxamine 5′-phosphate and also the inactive derivative pyridoxine 5′-phosphate. In some embodiments, the composition comprises vitamin B6 in the amount of about 50% to about 200%, including for example about 100% RDA. In some embodiments, the composition comprises about 0.6 to about 2.5 mg, including for example about 1.3 mg vitamin B6. In some embodiments, the composition comprises about 0.001% to about 0.005%, including for example about 0.002% to about 0.0025% vitamin B6.

In some embodiments, the micronutrient component further comprises vitamin B12. Vitamin B12 is unique among vitamins in that it contains a metal ion, cobalt, and is thus also referred to as cobalamin. In some embodiments, the composition comprises vitamin B12 in the amount of about 30% to about 150%, including for example about 50% to about 100%, or 66% RDA. In some embodiments, the composition comprises about 0.75 to about 3.5 μg, including for example about 1 to about 2 μg, or 1.6 μg vitamin B12. In some embodiments, the composition comprises about 0.0000015% to about 0.000005%, including for example about 0.0000027% vitamin B12. In some embodiments, the composition comprises at least about 0.5 mg vitamin B12, including for example at least about 1 mg, 1.5 mg, 2 mg vitamin B12. This is especially useful for elderly individuals, a large percent of whom do not readily absorb ingested vitamin B12.

In some embodiments, the micronutrient component further comprises vitamin C. Vitamin C, also known as ascorbic acid, is a water soluble vitamin. Unlike most mammals, humans and higher primates do not have the ability to make their own vitamin C and must obtain vitamin C with diet or supplements. Ascorbate is required for a range of essential metabolic reactions and severe deficiency causes scurvy in humans. In some embodiments, the composition comprises vitamin C in the amount of about 100% to about 400%, including for example about 140% to about 185% RDA. In some embodiments, the composition comprises about 100 to about 300 mg, including for example about 200 mg vitamin C. In some embodiments, the composition comprises about 0.15% to about 7%, including for example about 0.35% to about 4%, or 0.28% to about 0.33% vitamin C.

In some embodiments, the micronutrient component further comprises vitamin D. Vitamin D is a group of fat-soluble prohormones whose two major forms are vitamin D2 (or ergocalciferol) and vitamin D3 (or cholecalciferol). The term vitamin D also refers to metabolites and other analogues of these substances. In some embodiments, the composition comprises vitamin D in the amount of about 100% to about 400%, including for example about 100% to about 200% RDA. In some embodiments, the composition comprises about 200 to about 800 IU, including for example about 400 IU vitamin D. In some embodiments, the composition comprises about 0.15% to about 7%, including for example about 0.000008% to about 0.000034%, or 0.00001% to about 0.000017% vitamin D.

In some embodiments, the micronutrient component further comprises vitamin E. The term “vitamin E” used herein refers to a family of eight antioxidants, four tocopherols, alpha-, beta-, gamma-, and delta-, and four tocotrienols (also alpha-, beta-, gamma-, and delta--). In some embodiments, the vitamin E is alpha-tocopherol. In some embodiments, the composition comprises vitamin E in the amount of about 25% to about 100%, including for example about 50% RDA. In some embodiments, the composition comprises about 5 to about 20 mg, including for example about 10 mg vitamin E. In some embodiments, the composition comprises about 0.008% to about 0.034%, including for example about 0.017% vitamin E.

In some embodiments, the micronutrient component comprises vitamin K. In some embodiments, the vitamin K is vitamin K1. In some embodiments, alternative natural forms of vitamin K, MK7 or MK4, are included in the composition. In some embodiments, vitamin K1, MK7, and MK4 are included in the composition, or various combinations thereof. Vitamin K1 is directed primarily to the liver to ensure adequate coagulation function upon digestion. MK7 is a natural product of bacterial fermentation and is distributed more generally throughout the body to ensure adequate vitamin K for functions required for long term bone, heart, and immune health. In some embodiments, the composition comprises vitamin K (such as vitamin K1, MK7, or the combination of vitamin K1 and MK7) in the amount of about 20% to about 80%, including for example about 40% RDA. In some embodiments, the composition comprises about 25 to about 200 μg, including for example about 50 to about 100 μg vitamin K (such as vitamin K1, MK7, or the combination of vitamin K1 and MK7). In some embodiments, the composition comprises about 0.00005% to about 0.0004%, including for example about 0.0001% to about 00002% of vitamin K (such as vitamin K1, MK7, or the combination of vitamin K1 and MK7).

In some embodiments, the composition comprises a folate. Folate coenzymes play a vital role in DNA metabolism. Deficiency of folate can result in decreased synthesis of methionine and a build up of homocysteine, a risk factor for heart disease. Folate can be present, for example, in an amount that provides about 5% to about 50% RDA, including for example about 5% to about 10%, about 10% to about 20%, about 20% to about 30%, about 30% to about 40%, or about 40% to about 50% RDA. In some embodiments, the folate is present in the composition at an amount of more than about 10% RDA, including for example more than about any of 20%, 30%, 40%, or 50% RDA.

In some embodiments, the folate is a reduced form of folate. In some embodiments, the reduced folate is tetrahydrofolate, such as 5-methyl tetrahydrofolate (THF). In some embodiments, the composition comprises THF in the amount of about 50% to about 200%, including for example about 100% RDA. In some embodiments, the composition comprises about 200 to about 800 μg, including for example about 400 to about 800 μg THF. In some embodiments, the composition comprises about 0.0003% to about 0.0015%, including for example about 0.0006% to about 0.0008%, for example about 0.0007% THF.

In some embodiments, the micronutrient component in the composition comprises biotin. Biotin is a water soluble vitamin that particulates as a co-factor in gluconeogenesis, fatty acid synthesis, and branched chain amino acid catabolism. Biotin can be present in the composition at an amount that provides about 5% to about 100% RDA, including for example about 5% to about 10%, about 10% to about 20%, about 10% to about 30%, about 30% to about 40%, about 40% to about 50%, about 50% to about 60%, about 60% to about 70%, about 70% to about 80%, about 80% to about 90%, about 90% to about 100% RDA. In some embodiments, the biotin is present in the composition at an amount of no more than about 50% RDA, including for example no more than about any of 40%, 30%, 20%, 10%, or 5% RDA. In some embodiments, the composition comprises biotin in the amount of about 25% to about 100%, including for example about 50% RDA. In some embodiments, the composition comprises about 5 to about 30 μg, including for example about 10 μg to about 15 μg biotin. In some embodiments, the composition comprises about 0.00001% to about 0.00005%, including for example about 0.000025% biotin.

The composition of the present invention in some embodiments can also comprise choline, such as phosphatidyl choline. Choline and compounds derived from choline serve a number of vital biological functions, including synthesis of the phospholipids, phosphatidylcholine and sphingomyelin, two structural components of all human cell membranes. Choline is also important for methyl group metabolism and neurological function. The choline can be present in the composition at an amount that provides about 10% to about 100% RDA, including for example about 10% to about 20%, about 20% to about 40%, about 20% to about 60%, about 60% to about 80%, or about 80% to about 100% RDA. In some embodiments, the choline is present in the composition at an amount of no more than about 100% RDA, including for example no more than about any of 80%, 60%, 50%, 40%, 20%, or 10% RDA. In some embodiments, the composition comprises thiamin in the amount of about 20% to about 100%, including for example about 45% RDA. In some embodiments, the composition comprises about 100 to about 500 mg, including for example about 200 to about 300 mg choline. In some embodiments, the composition comprises about 0.1 to 0.8%, including for example about 0.4% choline.

### Minerals

Minerals described herein include, but are not limited to, calcium, magnesium, potassium, sodium, copper, iron, selenium, manganese, zinc, chromium, and mixtures thereof. In some embodiments, the vitamin component in the nutritional composition comprises at least three minerals selected from the group consisting of calcium, magnesium, sodium, copper, iron, selenium, manganese, zinc, chromium. In some embodiments, the micronutrient component does not comprise potassium, that is, the entire amount of potassium in the composition is obtained from the fruit component or the fiber component. In some embodiments, the micronutrient component comprises potassium, that is, additional potassium is added to the composition.

In some embodiments, the micronutrient component in the composition comprises chromium. Chromium is required for the normal metabolism of glucose, enhances the action of insulin, both influencing insulin receptor number and increasing insulin and leptin sensitivity. While some studies have shown that chromium supplementation improved some measure of glucose utilization or to have beneficial effects on blood lipid profiles, a recent, systematic review has concluded that the beneficial effects of chromium on glycemia can only be substantiated in patients with diabetes. The effect of chromium supplementation, especially on healthy individuals, thus was uncertain. The composition of the present invention in some embodiments include about 2.5% to about 25% chromium, including for example about 2.5% to about 10%, about 10% to about 20%, or about 20% to about 25% RDA. In some embodiments, the chromium is present at an amount of no more than about 25% RDA, including for example, no more than about any of 25%, 20%, 10%, or 2.5% RDA. In some embodiments, the composition comprises chromium in the amount of about 10% to about 40%, including for example about 22% RDA. In some embodiments, the composition comprises about 5 to about 50 μg, including for example about 10 to about 40 μg, for example about 30 μg chromium. In some embodiments, the composition comprises about 0.00001% to about 0.0001%, including for example about 0.00001% to about 0.00006%, such as about 0.00001% or 0.00005% chromium.

In some embodiments, the composition comprises calcium. In some embodiments, the calcium is provided in the forms of salts, such as CaCO₃, calcium citrate, calcium L-lactate, calcium phosphate salts, CaCl₂, and mixtures thereof. In some embodiments, the composition comprises calcium acetate. In some embodiments, the composition comprises calcium L-lactate. In some embodiments, the calcium is provided in the forms of calcium phosphate. Calcium phosphate is generally available as a monobasic, dibasic or tribasic salts. In some embodiments, the calcium material such as calcium carbonate and/or calcium phosphate salt has a particle size such that 90% has a particle size of less than 150 microns, that is, a fine powder. Having a calcium phosphate being of sufficiently reduced particle size is to avoid a “grittiness” organoleptic attribute in the finished dried fruit composition. In some embodiments, the calcium material has a particle size of less than 100 microns. In some embodiments, the weight ratio of calcium to magnesium in the composition is about 3:1 to about 1:3, including for example about 2:1 to about 1:2, such as about 1.2:1.

Calcium can be present, for example, in an amount of no more than about 25% AI, or no more than about 250 mg per bar. In some embodiments, the composition comprises calcium in the amount of about 25% to about 100%, including for example about 50% RDA. In some embodiments, the composition comprises about 250 to about 1000 mg, including for example about 500 mg to about 550 mg calcium. In some embodiments, the composition comprises about 0.5% to about 2%, including for example about any of 0.5%, 0.6%, 0.7%, 0.8%, 0.9%, or 1% calcium.

In some embodiments, the vitamin component comprises both calcium and sodium, wherein the weight ratio of calcium and sodium in the composition is at least about 1.5:1, 2:1, 3:1, 4:1, and 5:1. In some embodiments, the vitamin component comprises both calcium and magnesium, wherein the weight ratio of calcium and magnesium in the composition is at least about 1.5:1, 2:1, 3:1, 4:1, and 5:1.

In some embodiments, the composition comprises copper. Copper can be provided by Cu₂O, CuCl₂, CuSO₄, and mixtures thereof. In some embodiments, the composition comprises copper in the amount of about 20% to about 200%, including for example about 50% to about 100%, for example about 60% RDA. In some embodiments, the composition comprises about 100 to about 300 μg, including for example about 150 to about 200 μg, for example about 180 μg copper. In some embodiments, the composition comprises about 0.0001% to about 0.001%, including for example about 0.0003% copper.

In some embodiments, the composition comprises iron. Iron can be provided by iron citrate, ferritin iron, EDTA iron, ferric sodium pyrophosphase, and/or iron fumarate. In some embodiments, the iron is provided in the form(s) of iron chelates. Suitable iron chelates include, but are not limited to, EDTA iron chelate, DPTA iron chelate, and iron citrate. In some embodiments, the iron is provided in a natural form, for example, in the form of a protein complex naturally exist in the human body. In some embodiments, the composition comprises iron in the amount of about 10% to about 100%, including for example about 20% to about 80%, such as 50% RDA. In some embodiments, the composition comprises about 2 to about 10 mg, including for example about 4 mg iron. In some embodiments, the composition comprises about 0.002% to about 0.01%, including for example about 0.007% iron.

In some embodiments, the composition comprises magnesium (40%). Magnesium can be provided, for example, by MgO, MgCl₂, MgCO₂, Mg(OH)₂, magnesium acetate, magnesium L-lactate, and mixtures thereof. In some embodiments, the composition comprises magnesium acetate. In some embodiments, the composition comprise magnesium L-lactate. In some embodiments, the composition comprises magnesium in the amount of about 50% to about 200%, including for example about 90%, 93%, or 100% RDA. In some embodiments, the composition comprises about 150 to about 500 mg, including for example about 300 mg to about 400 mg magnesium. In some embodiments, the composition comprises about 0.2% to about 1%, including for example about 0.5% to about 0.6% magnesium.

In some embodiments, the micronutrient component comprises selenium. Selenium is a trace element that is essential in small amounts. Human and animals require It for the function of a number of selenium-dependent enzymes, known as selenoproteins. In some embodiments, the composition comprises selenium in the amount of about 5% to about 50%, including for example about 10% to about 30%, such as about 20% RDA. In some embodiments, the composition comprises about 1 to about 20 μg, including for example about 10 μg selenium. In some embodiments, the composition comprises about 0.00001% to about 0.00004%, including for example about 0.00002% selenium.

In some embodiments, the composition comprises zinc. Zinc is an essential trace element for all forms of life. Zinc can be provided, for example, by Zn-oxide, Zn-citrates, Zn-gluconates, Zn-stearates, Zn-amino acid chelates, Zn-ascorbates, and mixtures thereof. In some embodiments, the composition comprises zinc in the amount of about 25% to about 200%, including for example about 40%, 50%, or 100% RDA. In some embodiments, the composition comprises about 1 to about 10 mg, including for example about 4 mg to about 5 mg zinc. In some embodiments, the composition comprises about 0.004% to about 0.015%, including for example about 0.008% zinc.

In some embodiments, the composition (such as the micronutrient component of the composition) comprises an acetate. Acetate is readily converted to acetylCoA, which is utilized in the mitochondria to support cellular energy production. Delivery of 1.5 gm per day, in the form of the corresponding acid (acetic acid), reduces fat mass and triglyceride levels in obese men. In some embodiments, the composition comprises acetate in the amount of about 0.5 to 2.5 gm acetate, including for example about 1, 1.5, and 2 gm. Acetate can be provided, for example, in the form of a salt, such as calcium acetate, magnesium acetate, or potassium acetate.

In some embodiments, the composition (such as the micronutrient component of the composition) comprises a L-lactate. L-lactate is readily converted to pyruvate by L-lactate dehydrogenase, which is utilized in the mitochondria to support cellular energy production. Delivery of 1.335 gm per day, in the form of the corresponding acid (lactic acid), blunts indomethacin induced small intestinal injury, indicating a role in improving gut integrity. In some embodiments, the composition comprises L-lactate in the amount of about 0.5 to 2.5 gm L-lactate, including for example about 1, 1.5, and 2 gm. L-lactate can be provided, for example, in the form of a salt, such as calcium L-lactate, magnesium L-lactate, or potassium L-lactate.

In some embodiments, the micronutrient component in the composition comprises at least one amino acid. In some embodiments, the micronutrient component comprises at least one amino acid selected from the group consisting of isoleucine, leucine, methionine, lysine, phenylalanine, threonine, valine, and tryptophan.

### LCPUFA

Omega-3 long chain polyunsaturated fatty acids (LCPUFA) are important in brain development and long term health. Omega-3 LCPUFA, which is found primarily in fish oils, can also be synthesized in the body from alpha linolenic acid (ALA) found in nuts, and some vegetable and animal fats. However, the rate of synthesis of EPA and DHA from ALA may not be sufficient for optimal function. LCPUFA described herein include fish oil, eicosapentaenoic acid (EPA), blue algae omega-3, docosahexaenoic acid (DHA), and linolenic acid. In some embodiments, the LCPUFA is algae-derived DHA. In some embodiments, the composition comprises both omega-3 and omega-6 fatty acids. In some embodiments, the ratio of omega-3 and omega-6 fatty acids in the composition is less than about 5:1, including for example less than about 4:1, 3:1, 2:1, 1.6:1, or 1:1.

In some embodiments, the composition comprises about 100 to about 1000 mg, including for example about 300 to about 500 mg, such as about 400 mg or about 450 mg DHA. In some embodiments, the composition comprises about 0.1% to about 1%, including for example about 0.6% to about 0.7% DHA.

One significant challenge in compositions comprising omega-3 LCPUFA is that they get easily oxidized which adversely affects the taste of the composition. To circumvent this problem, a process of making the composition was developed in which the omega-3 long chain polyunsaturated fatty acid was first dissolved in melted chocolate and combined with the rest of the components along with the solidified chocolate. The chocolate melts at a low temperature and then solidifies easily. It traps the fatty acid inside when solid and separates the fatty acid away from oxidative components in the composition, such as minerals. In some embodiments, vitamin E is also added to the chocolate, thus further preventing the fatty acid from getting oxidized. Other oil soluble components (such as oil-soluble vitamins) can also be added to the melted chocolate.

Thus, in some embodiments, the composition comprises a omega-3 long chain polyunsaturated omega-3 fatty acid that is physically separated from the minerals in the composition. For example, the long chain polyunsaturated omega-3 fatty acid in the composition is entrapped in solidified chocolate. In some embodiments, the solidified chocolate further comprises vitamin E and/or beta-carotene, phosphatidyl choline, and vitamins D and K.

### Protein and Amino Acids

The composition described herein in some embodiments, comprises proteins, peptides, and/or amino acids. For example, the composition in some embodiments comprises whey protein or soy protein to provide essential amino acids such as tryptophan. In some embodiments, the composition comprises glutamine and/or another branched chain amino acid.

In some embodiments, the composition comprises whey protein. Whey protein can be provided, for example, in the amount of about 1 gram to about 10 grams, including about 5 grams. In some embodiments, the composition comprises about 1% to about 10%, including for example about 5% to about 9%, such as about 8% whey protein.

In some embodiments, the composition comprises glutamine. Glutamine can be provided, for example, in the amount of about 1 gram to about 4 grams, including about 2 grams. In some embodiments, the composition comprises about 1% to about 5%, including for example about 2% to about 4%, such as about 3% glutamine.

In some embodiments, the micronutrient component in the composition comprises at least one essential amino acid, for example an essential amino acid selected from the group consisting of isoleucine, leucine, methionine, lysine, phenylalanine, threonine, valine, and tryptophan. In some embodiments, the composition comprises conditionally essential amino acid glutamine. Glutamine can be present, for example, in an amount of about 0.1 to about 0.2 gm, about 0.2 to about 0.3 gm, about 0.3 to about 0.4 gm, about 0.4 to about 0.5 gm, about 0.5 to about 0.6 gm, about 0.6 to about 0.7 gm, about 0.7 to about 0.8 gm, about 0.8 to about 0.9 gm, about 0.9 to about 1 gm, about 1 gm, about 1 to about 2 gm). In some embodiments, the composition comprises nonessential amino acid taurine. Taurine can be present, for example, in an amount of about 50 to about 100 mg, about 100 to about 150 mg, about 150 to about 200 mg, about 200 to about 300 mg.

### Other Ingredients

The composition described herein may comprise one or more additional ingredients, which include lipids, carbohydrates, proteins and combinations thereof. In some embodiments, the composition comprises walnut pieces, almond pieces, or pieces of other nuts. In some embodiments, the composition comprises coffee. In some embodiments, the composition comprises, whey protein. In some embodiments the composition comprises, vanilla, cinnamon, mint, food grade acids, and/or food grade flavors to improve final product sensorial acceptability. In some embodiments, the composition comprises antioxidant rich spices such as, but not limited to, black pepper, cinnamon, cloves, garlic powder, ginger, oregano, paprika, rosemary, or tumeric.

In some embodiments, the amount of these other macronutrients in the composition is kept at minimum. For example, in some embodiments, the amount of macronutrients in the composition is less than about 10% of the total composition. In some embodiments, the amount of macronutrients in the composition constitutes less than about 10% total carbohydrates in the composition. In some embodiments, the amount of macronutrients in the composition constitutes less than about 10%, including for example less than about 5%, 1%, or 0.5% of the total calories in the composition.

### Product Forms

The nutritional compositions of the present invention may be formulated and administered in any known or otherwise suitable oral product form. Any solid, liquid, or powder form, including combinations or variations thereof, are suitable for use herein, provided that such forms allow for safe and effective oral delivery to the individual of the essential ingredients as also defined herein.

In some embodiments, the nutritional composition is provided in the form of nutrition bars. The nutrition bar in some embodiments is provided in a sealed package, for example a package sealed under nitrogen. In some embodiments, one or more nutrition bars are contained in a single sealed package.

In some embodiments, the nutritional composition is provided in the form of nutritional bites (e.g., a plurality of smaller dietary product dosage forms in a single package).

In some embodiments, the nutritional composition is provided in the form of nutritional sticks.

The nutritional compositions of the present invention in some embodiments can be formulated as liquids, such as milk-based liquids, soy-based liquids, low-pH liquids, and liquid reconstituted from powders. In some embodiments, the nutritional compositions are provided in the form of semi-liquids, such as yogurt. In some embodiments, the nutritional composition is provided in the form of kefir or sprinkles.

The nutritional compositions of the present invention may also include a variety of different product forms, including any conventional or otherwise known food product form, some non-limiting examples of which include confectionary products, cereals, food condiments (e.g., spreads, powders, sauces, jams, jelly, coffee creamer or sweetener), baking or cooking materials (e.g., flour, fats or oils, butter or margarine, breading or baking mixes), salted or seasoned snacks (e.g., extruded, baked, fried), beverages (e.g., coffee, juice, carbonated beverage, non-carbonated beverage, tea, ice-cream based drinks), snack or meal replacement bars, smoothies, breakfast cereals, cheeses, gummy products, salted or unsalted crisp snacks (e.g., chips, crackers, pretzels), dips, baked goods (e.g., cookies, cakes, pies, pastries, bread, bagels, croutons, dressings, dry mixes (e.g., mixes for muffins, cookies, waffles, pancakes, beverages), frozen desserts (e.g., ice cream, fudge bars, frozen yogurt), pudding, flavored or unflavored gelatin, refrigerated dough (e.g., cookies, bread, brownies), milk or soy-based smoothies, yogurt or yogurt-based drinks, frozen yogurt, soy milk, soups, and snacks.

The nutritional compositions of the present invention may also be formulated in product forms such as capsules, tablets, pills, caplets, gels, liquids (e.g., suspensions, solutions, emulsions), powders or other particulates, and so forth. These product forms preferably contain only the essential ingredients as described herein, optionally in combination with other actives, processing aids or other dosage form excipients.

### Methods of Making the Nutritional Compositions

Also provided herein are methods of manufacturing the nutritional compositions described herein.

Nutritional bars of the nutritional composition may be manufactured, for example, using cold extrusion technology as is known and commonly described in the bar manufacturing art. To prepare such compositions, typically all of the powdered components are dry blended together, which typically includes any proteins, vitamin premixes, certain carbohydrates, and so forth. The fat-soluble components are then blended together and mixed with any powdered premixes. Finally any liquid components are then mixed into the composition, forming a plastic like composition or dough. All of these steps must be performed at low temperatures to prevent degradation of nutrients during processing. The resulting plastic mass can then be shaped, without further physical or chemical changes occurring, by cold forming or extrusion, wherein the plastic mass is forced at relatively low pressure through a die, which confers the desired shape. The resultant exudate is then cut off at an appropriate position to give products of the desired weight. If desired the solid product is then coated, to enhance palatability, and packaged for distribution.

Alternately nutritional bars can be manufactured using a sheeting process. The plastic like composition or dough described above is spread on large sheets and then cut into bars using this process.

The solid nutritional embodiments for use herein may also be manufactured through a baked application or heated extrusion to produce solid product forms such as cereals, cookies, crackers, and similar other product forms. One knowledgeable in the nutrition manufacturing arts is able to select one of the many known or otherwise available manufacturing processes to produce the desired final product.

One major challenge in manufacturing nutritional compositions is to combine all the necessary ingredients into a single palatable form. Because components such as LCUPFAs carry an unpleasant taste, a major challenge was encountered when including the LCUPFA into the composition. We have found that the unpleasant taste of LCUPFA can be disguised by trapping it in chocolate, and masking with other flavors incorporated in the composition, including but not limited to ground coffee, citric acid, and freeze dried fruit powders. Trapping the LCPUFA in chocolate also allows physical separation of the LCPUFA from oxidative minerals which would otherwise oxidize the LCPUFA.

It was discovered that the processes of dry blending powdered components separately and combining all fat soluble ingredients with melted chocolate is essential to obtaining a nutritional bar with a good final product flavor, odor and texture. When fat soluble nutrients were not blended in melted chocolate prior to forming the dough, the final product was not sensorially acceptable. Furthermore, when dry powder ingredients were not pre-blended with the fruit component (such as fruit powders), final product sensory properties were not compromised.

The present invention, in some embodiments, provides a method of manufacturing a nutritional composition that is palatable. In some embodiments, there is provided a method of making a nutritional composition comprising chocolate and LCPUFA (such as some of the nutritional compositions described herein), the method comprising: 1) dissolving the LCPUFA in melted chocolate, and 2) combining the LCPUFA/chocolate mixture with at least one other component in the composition. In some embodiments, the method further comprises melting the chocolate. In some embodiments, the method further comprises solidifying the chocolate prior to combing the LCPUFA/mixture with the other component(s) in the composition. In some embodiments, the method further comprises adding one or more lipid soluble micronutrients, such as vitamin E, vitamin A, choline, DHA, and vitamin D, to the melted chocolate.

In some embodiments, there is provided a method of making a nutritional composition comprising a fruit component, a fiber component, chocolate, and a micronutrient component comprising LCPUFA, comprising 1) dissolving the LCPUFA in melted chocolate; and 2) combining said chocolate/LCPUFA mixture with other components in the composition. In some embodiments, there is provided a method of making a nutritional composition comprising a fruit component, a fiber component, chocolate, and a micronutrient component comprising LCPUFA, comprising 1) dissolving the LCPUFA in melted chocolate; and 2) combining said chocolate/LCPUFA mixture with the fruit component. In some embodiments, the method further comprises adding one or more lipid soluble micronutrients, such as vitamin E, vitamin A, choline, DHA, and vitamin D, to the melted chocolate. In some embodiments, at least three (such as at least any of four, five, six, seven, or eight) oil-soluble ingredients in the composition are dissolved in the chocolate prior to combining with the other components. In some embodiments, all oil-soluble ingredients in the composition are dissolved in chocolate prior to combining with the rest of the components.

In some embodiments, the chocolate with LCPUFA (and optionally other components) dissolved in is first solidified prior to combining with the other components. In some embodiments, the solidified chocolate is ground to powder prior to combining with the other components. In some embodiments, the chocolate with LCPUFA (and optionally other components) dissolved in is first combined with the other components before it is solidified.

Liquid, milk or soy-based nutritional liquids, for example, may be prepared by first forming an oil and fiber blend containing all formulation oils, any emulsifier, fiber and fat-soluble vitamins. Additional slurries (typically a carbohydrate and two protein slurries) are prepared separately by mixing the carbohydrate and minerals together and the protein in water. The slurries are then mixed together with the oil blend. The resulting mixture is homogenized, heat processed, standardized with any water-soluble vitamins, flavored and the liquid terminally sterilized or aseptically filled or dried to produce a powder.

We have also surprisingly found that using dried powder fruit component can increase the palatability of the nutritional composition. Thus, the present application in some embodiments provides a method of making a nutritional composition comprising a fruit component and a micronutrient (such as any of the nutritional compositions described herein), comprising combining a dry powdered form of the fruit component with the dry powder micronutrient component (such as the micronutrient component described herein).

### Methods of Using the Nutritional Compositions

The nutritional compositions described herein are useful for restoring/maintaining metabolic balance and reducing risk of diseases.

In some embodiments, there is provided a method of maintaining or restoring metabolic balance in an individual, comprising orally administering to the individual a nutritional composition comprising 1) a fruit component, 2) fiber component, and c) a micronutrient component. In some embodiments, there is provided a method of reducing risk of cardiovascular disease in an individual, comprising orally administering to the individual a nutritional composition comprising 1) a fruit component, 2) fiber component, and c) a micronutrient component. In some embodiments, there is provided a method of reducing risk of cardiovascular disease in an individual, comprising orally administering to the individual a nutritional composition comprising 1) a fruit component, 2) fiber component, and c) a micronutrient component. In some embodiments, there is provided a method of reducing risk of cancer in an individual, comprising orally administering to the individual a nutritional composition comprising 1) a fruit component, 2) fiber component, and c) a micronutrient component.

In some embodiments, there is provided a method of reducing risk of inflammation and other markers of diabetes or obesity in an individual, comprising orally administering to the individual a nutritional composition comprising 1) a fruit component, 2) fiber component, and c) a micronutrient component. In some embodiments, there is provided a method of improving markers of brain dysfunction and cognitive dysfunction in an individual, comprising orally administering to the individual a nutritional composition comprising 1) a fruit component, 2) fiber component, and c) a micronutrient component.

In some embodiments, there is provided a method of reducing risk of diabetes, metabolic syndrome, or obesity in an individual comprising orally administering to the individual a nutritional composition comprising 1) a fruit component, 2) fiber component, and c) a micronutrient component. In some embodiments, there is provided a method of improving cognitive function in an individual comprising orally administering to the individual a nutritional composition comprising 1) a fruit component, 2) fiber component, and c) a micronutrient component. In some embodiments, there is provided a method of inducing weight loss in an individual comprising orally administering to the individual a nutritional composition comprising 1) a fruit component, 2) fiber component, and c) a micronutrient component. In some embodiments, there is provided a method of reducing chronic inflammation in an individual comprising orally administering to the individual a nutritional composition comprising 1) a fruit component, 2) fiber component, and c) a micronutrient component. In some embodiments, there is provided a method of increasing satiety in an individual comprising orally administering to the individual a nutritional composition comprising 1) a fruit component, 2) fiber component, and c) a micronutrient component. In some embodiments, there is provided a method of improving dementia in an individual comprising orally administering to the individual a nutritional composition comprising 1) a fruit component, 2) fiber component, and c) a micronutrient component. In some embodiments, there is provided a method of improving lipid metabolism in an individual comprising orally administering to the individual a nutritional composition comprising 1) a fruit component, 2) fiber component, and c) a micronutrient component. In some embodiments, there is provided a method of improving immunity (e.g., innate or adaptive immunity) in an individual comprising orally administering to the individual a nutritional composition comprising 1) a fruit component, 2) fiber component, and c) a micronutrient component.

In some embodiments, there is provided a method of orally administering a nutritional composition to an individual, wherein said nutritional composition comprises 1) a fruit component, 2) fiber component, and 3) a micronutrient component, wherein said composition is in an amount that is effective for one or more of the following: restoring metabolic balance, reducing risk of cardiovascular disease, cancer, diabetes/obesity, and cognitive impairment.

In some embodiments, there is provided a method of orally administering a nutritional composition to an individual, wherein said nutritional composition comprises 1) a fruit component, 2) fiber component, 3) a micronutrient component, wherein said composition is in an amount that is effective for all of the following: restoring metabolic balance, reducing risk of cardiovascular disease, reducing risk of cancer, reducing risk of diabetes/obesity, improving cognitive function, raising HDL, improving the sizing profile of LDL (i.e., increasing the proportion of large buoyant LDL relative to small dense LDL, and the proportion of large buoyant HDL), lowering homocysteine, lowering LDL, reducing risk of cardiovascular diseases and dementia, improving biomarkers linked to gut health and metabolic syndrome, and increasing satiety. In some embodiments, the amount of the composition is effective in reducing DNA damage, reducing inflammation, improving innate or adaptive immunity, improving cognitive function, inducing weight loss, improving vascular function, and improving metabolic syndrome markers such as blood pressure, ectopic adipose deposition, HOMA-IR, and insulin sensitivity. In some embodiments, the composition is administered along with water.

In some embodiments, the individual is a healthy individual. In some embodiments, the individual is an obese individual. In some embodiments, the individual is an overweight individual. In some embodiments, the obese individual has a body mass index (BMI) greater than 30. In some embodiments, the obese individual has a BMI greater than the 95^{th} percentile of all people in the individual's age group. In some embodiments, the overweight individual has a BMI greater than 25. In some embodiments, the individual is younger than about 60 years old (including for example an individual younger than about 50, 40, 30, 25, 20, 15, or 10 years old). In some embodiments, the individual is older than about 60 years old (including, for example, 70, 80, 90, or 100 years old). In some embodiments, the individual is diagnosed or genetically prone to one or more of the risks of developing one or more diseases described herein. In some embodiments, the individual has one or more risk factors associated with one or more diseases discussed herein.

The nutritional composition can be administered at any desired frequency. In some embodiments, the composition is administered once daily, twice daily, thrice daily, or more frequently. In some embodiments, the nutritional composition is administered along with food. In some embodiments, the nutritional composition is not administered along with food. In some embodiments, the nutritional composition is administered on an empty stomach. In some embodiments, the nutritional composition is administered in conjunction with other dietary supplements. In some embodiments, the composition is administered in conjunction with water.

The following non-limiting examples further illustrate the compositions and methods of the present invention. Those skilled in the art will recognize that several embodiments are possible within the scope and spirit of this invention. The invention will now be described in greater detail by reference to the following non-limiting examples. The following examples further illustrate the invention but, of course, should not be construed as in any way limiting its scope.

### EXAMPLES

### Example 1. Methods of Making Exemplary Nutritional Compositions

This Example provides exemplary methods for making nutrition bars (chocolate espresso fruit bars).

A dry mix containing bran, soluble fiber, whey protein, coffee and dry vitamin mix were weighed and mixed in a commercial type mixer. A fruit/chocolate mix was made by heating chocolate and fruit concentrate to 38° C. in a steam jacketed kettle until fully liquid. Liquid fat soluble nutrients were added to the warm fruit chocolate. Walnut pieces were added if needed and the fruit chocolate was mixed well to disperse the fat soluble nutrients.

The dry mix (Part 1) was slowly mixed into the steam jacketed kettle containing the warm fruit chocolate mix (Part 2). Once parts 1 and 2 were fully mixed the warm mix was loaded into the hopper of a Vemag Robot 500 forming machine. The forming machine was adjusted to deposit desired bar size and bars were run onto a conveyor where cooling and packing occurred.

Table 5 provides exemplary compositions made with the methods described herein.

TABLE 5

| | Part 1 | Part 2 | Total |
|---|---|---|---|
| Bar Sample | 1.75 g espresso coffee (5%) | 10.7 g chocolate (30%) | 35.2 g total |
| #1 | 2.5 g whey (7.1%) | 9.0 g fruit conc. Mix (26%) | (100%) |
| | 4 g wheat bran (11.3%) | 0.4 g fruit flavor (1.2%) | |
| | 4 g beta glucan (11.3%) | 0.53 mg beta carotene (0.0015%) | |
| | 1.087 g vitamin mix (3.1%) | 5.6 mg vit E (0.02%) | |
| | | 200 mg choline (0.6%) | |
| | | 571 mg DHA (1.6%) | |
| | | 1 g walnuts (2.8%) | |
| Bar Sample | 2.5 g whey (7.5%) | 10.7 g chocolate (32%) | 33.45 g total |
| #2 | 4 g wheat bran (12%) | 9.0 g fruit conc. Mix (27%) | (100%) |
| | 4 g beta glucan (12%) | 0.4 g fruit flavor (1.2%) | |
| | 1.087 g vitamin mix (3.2%) | 0.53 mg beta carotene (0.0015%) | |
| | | 5.6 mg vit E (0.02%) | |
| | | 200 mg choline (0.6%) | |
| | | 571 mg DHA (1.7%) | |
| | | 1 g walnuts (3%) | |
| Bar Sample | 2 g whey (7.3%) | 10 g Apple puree (36.6%) | 27.3 g |
| #3 | 2 g beta glucan (7.3%) | 10 g fruit conc. Mix (36.6%) | (100%) |
| | 1.087 g vitamin mix (4%) | 0.4 g fruit flavor (1.5%) | |
| | | 0.53 mg beta carotene (0.0015%) | |
| | | 5.6 mg vit E (0.02%) | |
| | | 200 mg choline (0.7%) | |
| | | 571 mg DHA (2%) | |
| | | 1 g walnuts (3.7%) | |

### Example 2. Pilot Trials on the Nutritional Supplement

To study the effects of the nutritional composition, a series of small in-house pilot trials were conducted with the nutritional compositions to test safety, compliance, palatability, and short-term metabolic effects in healthy adult volunteers. The ingredients of the bar used in the present example are provided in Table 6.

TABLE 6

| Vitamins, minerals (% RDI or gm amount per bar) | | | Whole Food Matrix | Other Ingredients |
|---|---|---|---|---|
| β-carotene (0.46 mg) | 5-Methyl-H₄-folate (50%) | Vitamin B12 (50%) | Blueberries (2.5 g) | Whey Protein Isolate (2.5 g) |
| Biotin (25%) | Niacin (50%) | Vitamin B6 (50%) | Red Grapes (2.5 g) | Soluble Fiber-bete glucan (2 g) |
| Calcium (25%) | Pantothenic Acid (25%) | Vitamin C (90%) | Dried Plums (2.5 g) | Insoluble Fiber- wheat bran (4 g) |
| Chromium (22%) | Phosphatidyl choline (25%) | Vitamin D3 (200 IU) | Cranberries (2.5 g) | Added flavors |
| Copper (30%) | Potassium (5%) | Vitamin E (mixed tocopherols) | Dark Chocolate (10 g) | Natural Blueberry fruit flavor |
| Iron (25% M; 6% F) | Riboflavin, Vit B1 (50%) | (50% of alpha tocopherol) | Walnuts (2 g) | Citric Acid coating (sweet-sour) |
| Magnesium (50%) | Selenium (10%) | Vitamin K: phylloquinone | | or Decaf Espresso beans |
| | | (Vit K1) (50%) | | |
| Manganese (720%) | Thiamin (50%) | Zinc (25%) | Nutrition Facts* | |
| Supplemental Fatty Acid and Amino Acid | | *Nutrition Facts listed combine | Total Calories -100 | Sodium (55 g) |
| DHA (200 mg) | Glutamine (1 gm) | added ingredients with a partial | Calories from Fat- 35 | Tot Carbohydrate (13 g) |
| | | chemical analysis of supplement | Tot Fat (3.5 g) | Dietary Fiber (6 g) |
| | | matrix [Note: We were not sure | Saturated Fat (2 g) | Sugars (5 g) |
| | | how to handle the fact that we have | Trans Fat (0 g) | Protein (4 g) |
| | | measured values available for some | | |
| | | but not all items listed. We have | | |
| | | listed measured values when available, | | |
| | | and when not available have listed | | |
| | | the added amounts. | | |

A small set of bioassays was employed to assess standard clinical markers including a lipid panel indicating levels and phenotypes of HDL and LDL, a standard measure of insulin sensitivity, and C-reactive protein (CRP), and measure of inflammatory status. Also included in the pilot trials was a newly developed metabolomics assay that assessed overall oxidative status by profiling thiol redox and other amino acid-derived metabolites. Reference: J. Suh et al J. Chromatog B 877 (2009) 3418-27

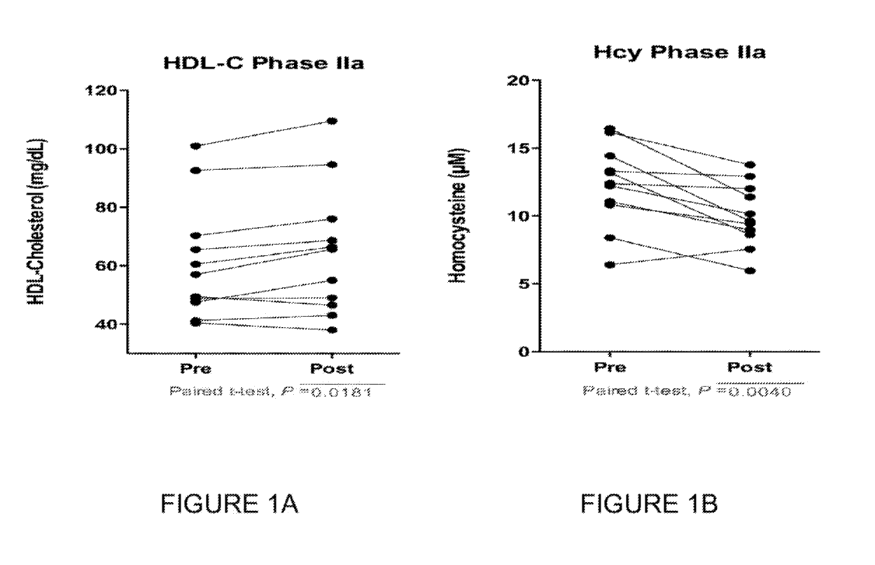

The trial results showed that consumption of the nutritional composition for at least two weeks by healthy or obese adults resulted, on average, in an approximately 5% rise in HDL. FIG. 1a shows the statistically significant (p=0.018) rise in HDL observed in a two-week trial involving 11 healthy adults. FIG. 1b shows that the nutritional composition also results in lowering of homocysteine.

### Example 3. Deconstruction Experiment with a Nutritional Supplement

We conducted several experiments to determine components in the nutritional composition that are important for the effects we have observed. Table 7 summarizes the results we have obtained.

TABLE 7

| Trial conditions | | | | |
|---|---|---|---|---|
| (All 2 wk unless | | | | |
| otherwise specified) | HDL | Homocysteine | LDL | LDL size profile |
| Complete formulation | ↑ 6.2%, | ↓ 19%, | n.s. | ↑ Large buoyant |
| (results pooled from 3 | p = 0.001 | p = 0.006 | | (trend: p = 0.086) |
| trials, n = 25) | (↑ in type IIb | | | |
| | HDL-large, buoyant) | | | |
| Complete formulation | ↑ 5.7%, | ↓ 18.7%, | n.s. | n.s. |
| n = 11 | p = 0.018 | p = 0.004 | | |
| | (↑ in type 2b | | | |
| | HDL-large buoyant) | | | |
| #1. Fruit alone (n = 17) | n.s. | n.s. | n.s. | Not done |
| #2. Fruit + β-glucan | n.s. | Pending | n.s. | Not done |
| (n = 12) | | | | |
| #3. Bar - fruit/β-glucan + | n.s. | ↓ 20%, | ↑ 13%, | Pending |
| fruit sugar (n = 10) | | p = 0.004 | p = 0.042 | |
| #4. Bar - beta-glucan | n.s. | Pending | n.s. | Not done |
| (n = 5) | | | | |
| #5. Bar + ½ and ½ beta- | n.s. | n.s. | n.s. | n.s. |
| glucan + inulin (n = 12) | | | | |
| #6. Bar + ½ beta-glucan + | n.s. at 2 wk | n.s. | ↓ 6% at 2 wk | n.s. |
| ½ NON-FERMENTABLE | ↑ 5.8% at 8 wk | (at 2 & 8 wk) | p = 0.007 | (at 2 & 8 wk) |
| SOLUBLE FIBER | p = 0.04 | | ↓ 7% at 8 wk | |
| (Note this trial had both 2 wk | (↑ in type IIb HDL) | | p = 0.012 | |
| and 2 mo time points) | | | | |

| | |
|---|---|
| #7. Bar - micronutrients | not done |
| #8. Bar - DHA | not done |
| #9. Bar - fruit | not done |

#1: A two week trial was conducted with the fruit concentrate alone (n=17), with no effect on HDL, homocysteine, or LDL.

#2. A mixture of the fruit and beta-glucan components of the bar were employed in a twice-daily consumption 2-week trial (n=12). Again, no significant changes were observed in HDL or LDL.

#3. The bar minus fruit and soluble fiber was employed in a twice-daily consumption 2-week trial. In this trial, in order to make the bar palatable, a mixture of fructose and glucose equivalent to that in the fruit components was added to the bar minus fruit and soluble fiber. Results of this trial showed no significant changes in HDL (either before or after removal of 2 outliers, one with a large increase and one with a large decrease in HDL). Results for homocysteine were similar to those for the complete bar, consistent with the presence of the B vitamins that remained in the bar minus fruit and soluble fiber. There was also, for the first time, a significant unfavorable rise in LDL. Results on the lipid sizing profile are pending.

#4. Bar—minus beta-glucan (no-beta glucan added to these bars-no source of soluble fiber)

#5. Bar with less beta-glucan+inulin (same total soluble fiber—½ the usual dose of beta glucan plus ½ as inulin)

#6. Bar with less beta-glucan+HPMC (same total soluble fiber—½ the usual dose of beta glucan plus ½ as HPMC).

Results of trials with the complete formulation and the above 3 formulations indicate a synergistic effect of combining fruit and soluble fiber with the other bar components: the beneficial changes in HDL and possibly LDL (pending results to be analyzed) occur with consumption of the full bar, but not with consumption of a bar with fruit and soluble fiber removed, and not with fruit and soluble fiber alone, or with fruit alone.

We believe the rise in LDL in the bar without fruit and soluble fiber may be due to the added sugar mixture, since it is known that refined sugars can raise LDL (Reiser et al (1989) AJCN 49:832-8). We think that may be due to the fact that, in the bar without fruit and soluble fiber, the lipogenic impact of fruit sugar was not attenuated by the fruit antioxidant and soluble fiber matrix, as it was when consumed in the full bar or in the combination of fruit and soluble fiber. This observation has important relevance to nutrition bars currently on the market, as many contain refined sugar without a fruit and soluble fiber matrix.

As shown in Table 7, twice daily consumption of the nutritional composition for two weeks by healthy adults in pooled results from three identical trials improved three markers of heart disease risks consistently, resulting in a statistically significant rise in HDL, a significant decrease in homocysteine, and a significant shift in the HDL profile to the large buoyant species. Pooled results from three trials and from one of the three trials pooled are shown in Table 7.

While the fruit and beta-glucan are required for the increase in HDL, these components themselves do not increase HDL; only the complete bar is effective. Furthermore, among the three soluble fibers tested, namely, beta-glucan, inulin, and a non-fermentable soluble fiber, only beta-glucan was both effective in raising HDL and palatable.

### Example 4. RDA and AI Values of Ingredients

Table 8 summarizes the known RDA and/or AI values of the various ingredients discussed herein.

TABLE 8

| | RDA or AI | |
|---|---|---|
| | (adult male listed | |
| | unless otherwise | |
| Ingredients | indicated) | |
| Vitamin A | Adult males: 900 μg | |
| | RAE/d ≅ 2500 IU VitA | |
| | Adult females: 700 μg | |
| C | 90 | mg |
| D | 200 | IU |
| E | 15 mg (α- | |
| | tocopherol) | |
| K | 120 | μg |
| Thiamin | 1.2 | mg |
| Riboflavin | 1.3 | mg |
| Niacin | 16 | mg |
| B6 | 1.3 | mg |
| Folic acid | 400 μg (folate) | |
| 5-Methyl-H₄- | 400 μg (folate) | |
| folate | | |
| B12 | 2.4 μg (cyano- | |
| | cobalamin) | |
| Biotin | 30 | μg |
| Pantothenic acid | 5 | mg |
| Calcium | 1000 | mg |
| Phosphorus | 700 | mg |
| Iodine | 150 | μg |
| Iron | 8 | mg |
| Magnesium | 400-420 mg (410 avg | |
| | was used) | |
| Zinc | 11 | mg |
| Selenium | 55 | μg |
| Copper | 900 | μg |
| Manganese | 2.3 | mg |
| Chromium | 35 | μg |
| Molybdenum | 45 | μg |
| Chloride | 2300 | mg |
| Potassium | 4700 | mg |
| Boron | Not established (NE) | |
| Nickel | NE | |
| Silicon | NE | |
| Tin | NE | |
| Vanadium | NE | |
| Lutein | NE | |
| Lycopene | NE | |
| DHA | NE | |
| Choline | 550 | mg |

| | |
|---|---|
| Glutamine | NE |
| Whey protein | ≅15% total calories |
| isolate | as protein |
| | recommended |
| Soluble fiber: | 25-38 g total fiber |
| Beta-glucan | recommended |
| Insoluble fiber: | 25-38 g total fiber |
| wheat bran | recommended |

### Example 5. Sheeting Method—Methods of Making Exemplary Nutritional Compositions Incorporating Fruit Powder

This Example provides exemplary methods for making CHORI Coated Bars that utilizes a sheeting method.

Preparation of Ingredients:

a fruit concentrate blend is prepared and walnuts are chopped to provide bits ranging from paste to chunks for addition to a Wet Mix. Similarly, dry vitamins are weighed and premixed, bran is ground to a fine powder, and coffee is ground to desired grind (fine or coarse) for addition to a Dry Mix.

Preparation of Mixes:

Dry Mix ingredients listed in Table 9 below are weighed and mixed in a commercial type mixer. For the Wet Mix, chocolate and fruit concentrate are heated to 38° C. in a steam jacketed kettle or other heating device until fully liquid. Liquid fat soluble nutrients are added to the warm fruit chocolate. Walnut paste or pieces are added and the fruit chocolate is mixed well to disperse the fat soluble nutrients.

TABLE 9

| | | |
|---|---|---|
| | Amount Added | Elemental |
| Nutrient | to One Bar | Amount per Bar |

| | | | | |
|---|---|---|---|---|
| Wet Mix | | | | |
| Chocolate | 10 | g | 10 | g |
| Blueberry Conc. | 5 | g | 5 | g |
| Grape Conc. | 5 | g | 5 | g |
| Vegetable Glycerin | 1 | g | 1 | g |
| Flavor | .4 | g | .4 | g |
| Choline | .2 | g | .2 | g |
| Vit A | .53 | mg | 0.159 | mg |
| Walnut Paste | 1 | g | 1 | g |
| Vit E | 5.6 | mg | 5 | mg |
| Vit D3 | 3.11 | mg | 1936 | IU |
| DHA - HM | .571 | g | 0.2 | g |
| MK-7 | 16.7 | mg | 0.167 | mg |
| Dry Mix | | | | |
| Blueberry Powder | 5 | g | 5 | g |
| Whey Protein | 2.5 | g | 2.5 | g |
| Bran | 4 | g | 4 | g |
| Beta Glucan | 3.6 | g | 1.8 | g |
| Glutamine | 1 | g | 1 | g |
| scFOS | 1 | g | 1 | g |
| PChem Mix (see Table 9) | 0.881 | g | 0.881 | g |
| Ca Lactate | .49 | g | 68 | mg |
| Iron | 4 | mg | 2 | mg |
| Coffee | 1 | g | 1 | g |

TABLE 10

| PChem Nutrient Blend | (g) |
|---|---|
| Calcium Phosphate | 488 |
| Chromium | 1.65 |
| Copper | 0.125 |
| Magnesium Oxide | 258 |
| Selenium | 0.26 |
| Zinc | 2.96 |
| Biotin | 0.75 |
| 5-Methyltetrahydrofolate | 16.5 |
| Niacin | 7.5 |
| Panthanoic Acid | 1.36 |
| Riboflavin | 0.6 |
| Thiamin | 0.4 |
| Vitamin B6 | 0.66 |
| Vitamin B12 | 0.008 |
| Vitamin C | 100 |
| Vitamin K1 | 2.5 |
| Total | 881.3 |

Bar Formation:

The Dry Mix (Part 1) is slowly mixed into the steam jacketed kettle containing the warm fruit chocolate mix (Part 2). Once parts 1 and 2 are fully mixed the warm mix is loaded into a sheeting apparatus, sheeted and cut into bars of appropriate portion. The bars are coated with white chocolate mint, cinnamon and sugar, white chocolate blueberry, chocolate powder or other coatings. The bars are cooled and packaged. Packaging may include nitrogen flushing to limit oxidation of product in package.

### Example 6. Pilot Interventions in Healthy Adults with Nutritional Bar Composition

This Example shows pooled results from three 2-week pilot interventions conducted with an exemplary composition of the invention, a nutrition bar, in adults eating relatively good diets. Plasma metabolic biomarkers in the study reported here include a standard lipid panel, a particle size analysis of HDL and LDL sub-species, ApoA1 (the primary lipoprotein in HDL), a thiol amino acid/redox panel, hCRP (a marker of inflammatory status), and several biomarkers related to glucose metabolism.

Nutrition Bar:

The ingredients of the exemplary composition of the invention used in the present example are provided in Table 11.

TABLE 11

| | Amounts | |
|---|---|---|
| Bar Ingredients | All B vits adjusted to 50% RDA; less coffee | |
| beta carotene | 0.16 | mg |
| biotin | 0.0075 | mg |
| calcium | 275 | mg |
| choline | 124 | mg |
| chromium | 0.0165 | mg |
| copper | 0.09 | mg |
| DHA | 200 | mg |
| 5-methylT4 - folate | 0.2 | mg |
| Glutamine | 1 | g |
| insoluble fiber | 4 g wheat bran | |
| iron | 2 | mg |
| lactate | — | |
| magnesium | 150 | mg |
| manganese | NONE | |
| niacin | 7.5 | mg |
| pantothenic acid | 1.25 | mg |
| potassium | NONE | |
| riboflavin | 0.6 | mg |
| selenium | 0.0055 | mg |
| soluble fiber | 2 g β glucan | |
| vitamin B6 | 0.65 | mg |
| vitamin B12 | 0.8 | mcg |
| vitamin C | 100 | mg |
| vitamin D3 | (200 | IU) |
| vitamin E (mixed toc) | 5 | mg |
| vitamin K-1 | 0.0375 | mg |
| MK-7 | — | |
| thiamine | 0.4 mg already 40% | |
| whey protein | 2.5 | g |
| zinc | 2.375 | mg |
| Fruit concentrate** | 10 g: 25% each Blueberry, | |
| | Dried Plum, Cranberry, | |
| | Red Grape | |
| Natural blueberry flavor | 0.4 | g |
| Freeze-dried blueberry | — | |
| Dark Chocolate | 10 | g |
| Walnuts | 1 | g |
| Glycerine | 1 | g |
| +/−Espresso beans | +/−1 | g |

| | |
|---|---|
| or citric acid coating | +/−coating |

Study Participants:

Twenty-five generally healthy adults across a wide range of ages (19 to 81 yr) and body mass indices participated in a series of three two week trials of twice daily intake of the nutrition bar. Exclusion criteria were intercurrent infectious disease, untreated hypertension or medication for diabetes or dyslipidemia. Baseline characteristics of the study participants are shown in Table 12.

TABLE 12

| | Participants |
|---|---|
| Variable | (n = 25) |
| Asian American | 7 (28%) |
| Caucasian | 17 (68%) |
| Hispanic | 1 (4%) |
| Females | 15 (60%) |
| Males | 10 (40%) |

Mean ± SD (min, max)

| | |
|---|---|
| Age | 44.9 ± 15.8 |
| | (19, 81) |
| BMIⁱ | 25.7 ± 14.3 |
| | (17, 31) |

ⁱBMI was not measured in one participant.

Participants were advised to discontinue all vitamin, mineral, and fiber supplements and any other nutraceuticals two weeks prior to the initiation of each trial. Compliance with these guidelines as well as absence of intercurrent infectious disease was assessed by self-report. Consumption of 2 bars each day was advised, with the first to be eaten before noon and the second bar in either the afternoon or evening. Subjects were advised to drink a minimum of 8 oz of water with each bar. No guidelines as to whether to use the bar as a meal replacement or a supplement were given, but self-report satiety scores before and 20 min following intake were collected. Baseline and 2-week visits to the clinical research center included measurements of height, weight and waist circumference taken 1 cm above the iliac crest. Each physical measurement was taken twice and averaged. Blood pressure and heart rate (Dynemapp) were assessed in triplicate and averaged. Fasting venous blood samples were taken in ethylenediaminetetraacetic acid (EDTA)-containing tubes and immediately processed.

Anthropometric and biochemical changes in study participants consuming the nutrition bar are shown in Table 13ⁱ.

TABLE 13

| | | Two week | | |
|---|---|---|---|---|
| | | nutrition bar | | |
| Variables | Baseline | consumption | Change | P value |
| Anthropometric Measures | | | | |
| Systolic blood pressure | 119.3 ± 12.1 | 117.6 ± 16.7 | −1.6 ± 10.8 | 0.444 |
| (mmHg) | | | | |
| Diastolic blood pressure | 76.7 ± 8.9 | 74.0 ± 8.8 | −2.7 ± 9.4 | 0.169 |
| (mmHg) | | | | |
| Weight | 71.9 ± 14.0 | 72.3 ± 13.9 | 0.4 ± 1.3 | 0.163 |
| Waist circumference | 89.2 ± 12.7 | 87.7 ± 11.2 | −1.5 ± 3.3 | 0.068 |
| Satiety scores | 5.9 ± 1.6 | 2.7 ± 1.8 | −3.2 ± 2.1 | <0.0001 |
| Biochemical Measures | | | | |
| (in plasma) | | | | |
| Total Cholesterol (mg/dl) | 205.9 ± 42.7 | 207.4 ± 48.2 | 1.5 ± 24.0 | 0.754 |
| HDL Cholesterol (mg/dl) | 56.3 ± 17.8 | 59.8 ± 18.7 | 3.5 ± 4.8 | 0.001 |
| HDL 3-2aⁱⁱ (nmol/L) | 4439.8 ± 1454.4 | 4293.8 ± 1711.7 | −146.0 ± 1189.3 | 0.545 |
| Large Buoyant HDL (HDL | 1665.9 ± 1017.7 | 2089.4 ± 1197.6 | 423.5 ± 374.1 | <0.0001 |
| 2b) (nmol/L) | | | | |
| LDL Cholesterol (mg/dl) | 124.6 ± 39.7 | 126.5 ± 43.0 | 1.9 ± 14.3 | 0.524 |
| LDL Peak Diameterⁱⁱ (Å) | 222.9 ± 7.5 | 224.6 ± 8.3 | 1.7 ± 4.7 | 0.086 |
| Triglycerides (mg/dl) | 124.7 ± 80.9 | 118.9 ± 57.9 | −5.8 ± 48.7 | 0.554 |
| High Sensitivity C-reactive | 1.8 ± 2.2 | 1.5 ± 1.5 | −0.3 ± 1.2 | 0.241 |
| protein (hsCRP) (mg/L) | | | | |
| Homocysteine (tHcy) | 12.6 ± 6.4 | 10.2 ± 3.7 | −2.4 ± 3.6 | 0.006 |
| (μmol/L) | | | | |
| Fasting Blood Glucose | 99.2 ± 13.2 | 97.4 ± 15.3 | −1.8 ± 8.6 | 0.329 |
| (mg/dl) | | | | |
| Fasting Insulin (mU/L) | 9.7 ± 5.3 | 9.0 ± 4.5 | −0.8 ± 3.6 | 0.312 |
| Homeostasis Model | 2.4 ± 1.3 | 2.2 ± 1.1 | −0.2 ± 1.0 | 0.276 |
| Assessment of Insulin | | | | |
| Resistance (HOMA/IR) | | | | |

ⁱ Systolic and diastolic blood pressure, weight, and waist circumference was not measured in one individual. Other biochemical endpoints measured were 44 thiol redox couples and amino acid metabolites.
ⁱⁱHDL 3-2a represents a combination of HDL particles belonging to one class (HDL 2a) of large buoyant HDL and all members of the class of small dense HDL (HDL 3a, HDL 3b, and HDL 3c).
ⁱⁱⁱ LDL peak diameter represents the average size of all LDL particles.

Results:

No significant side effects were reported. Participants consistently reported a significant decrease in hunger on an analog hunger scale after consuming each bar, and in this regard it is notable that there was no weight gain over the course of the trials (p=0.16) despite a daily increase in intake of approximately 220 calories by Medallion analysis.

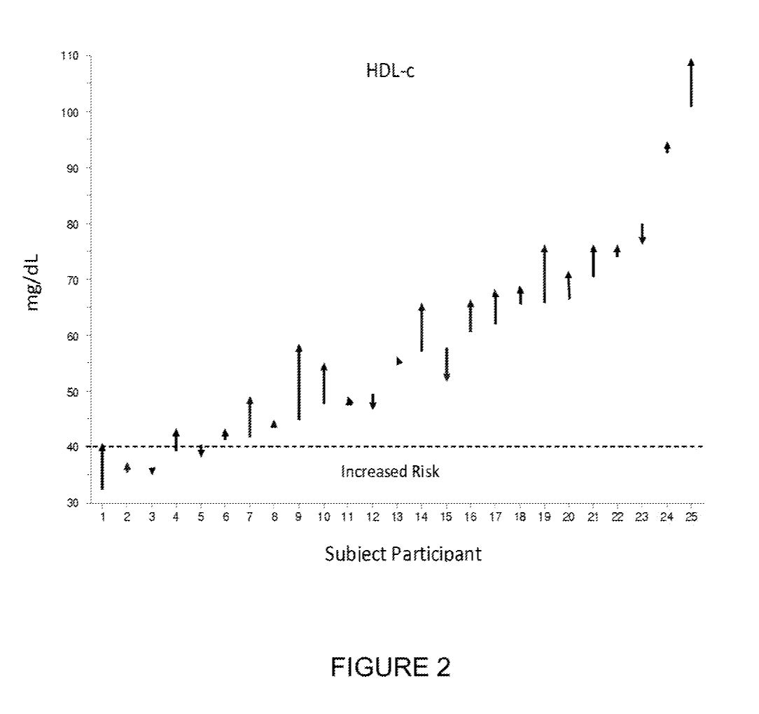

As shown in FIG. 2, baseline HDL-c varied greatly among the study population, with baseline values ranging from 32.3 mg/dL to 100.9 mg/dL. Increases in HDL-c occurred across the full range of these values, including in the individuals who began the study with the lowest (subject #1) and the highest (subject #25) baseline values who experienced an absolute increase in HDL-c of 8.2 mg/dL and 8.6 mg/dL respectively. Five individuals began the study with HDL-c values at or below 40 mg/dL, the clinical cut-off considered to indicate increased risk of CVD.

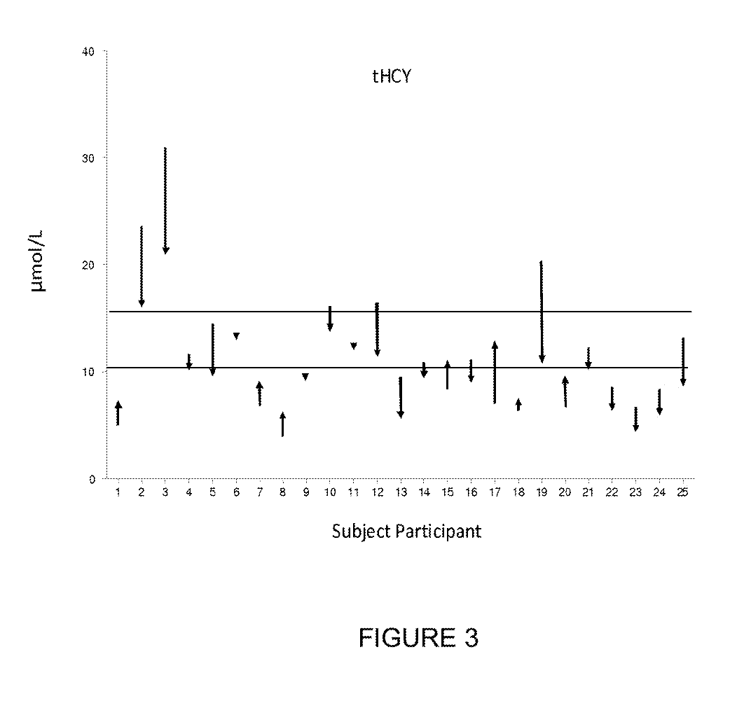

tHcy above 10 μM is associated with increased risk for cardiovascular disease. As shown in FIG. 3, among the 25 participants, 13 individuals (52%) were above this cutoff value. tHcy concentrations decreased post-intervention in 11 (85%) of these 13 subjects, with three individuals with the highest baseline tHcy values responding the most robustly. By comparison, in those with tHcy below 10 μM, only 4 of 12 subjects (33%) exhibited a postintervention decline. This suggests that subjects in the high-risk category were more sensitive to the tHcy-lowering effect of this nutritional intervention.

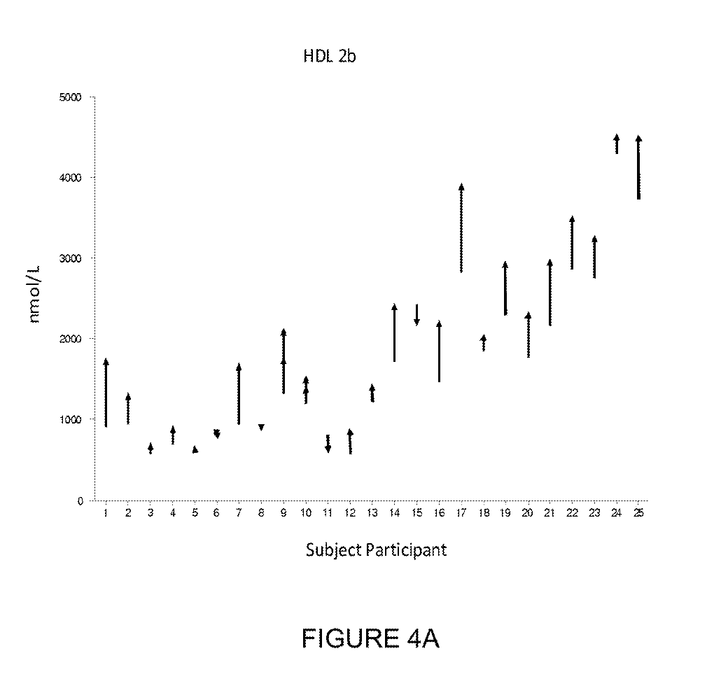

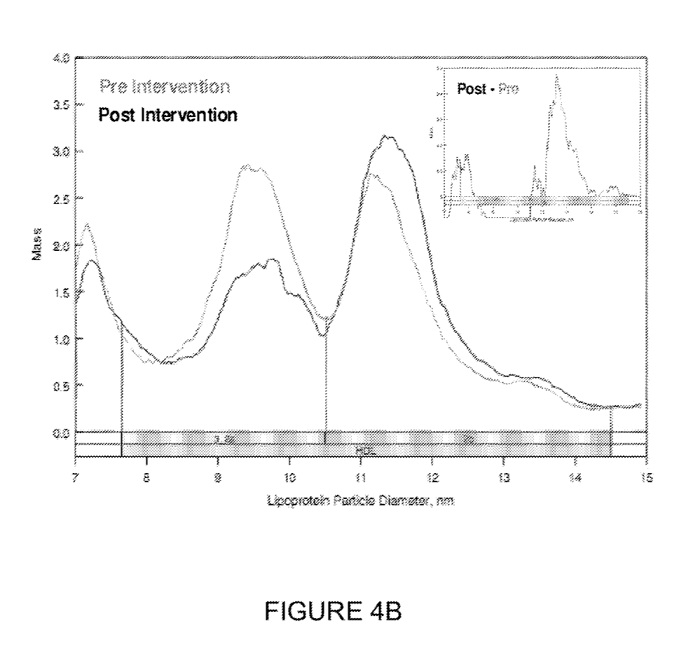

Concentrations of HDL 2b were determined alongside the particle concentrations for HDL 3_2a (7.5 to 10.4 nm particle diameter range), a composite of the small dense HDL 3a, 3b, and 3c subclasses combined with larger, buoyant HDL 2a subclass. Results for HDL2b are shown in FIG. 4A. As can be seen by comparing FIGS. 2 and 4A, HDL2b favorably increased in about 80% of participants, in some instances as a shift in HDL subspecies without any change in total HDL-c.

There was an overall increase in both the size and buoyancy of the HDLP population following intervention. In contrast to plasma concentrations of HDL2b, those of HDL 3_2a were not altered significantly (Table 13), possibly since this HDL subclass represents a combination of particle sizes and buoyancies (Rosenson, et al., Clin Chem, 57:392-410 (2011)). The greater percentage of study participants responding with a rise in HDL2b compared to HDL-c prompted us to examine in more detail the post-intervention shifts in HDLP size classes in those individuals with either no apparent change or decrease in HDL-c. Interestingly, ion mobility analysis of the six individuals that conformed to this criterion, indicated that a shift in the relative mass of HDL 3_2a towards HDL 2b occurred in all 6 individuals (see FIG. 4B for a representative plot). Furthermore, tHcy, an independent risk marker of cardiovascular disease, also decreased in each of these six individuals (FIG. 3).

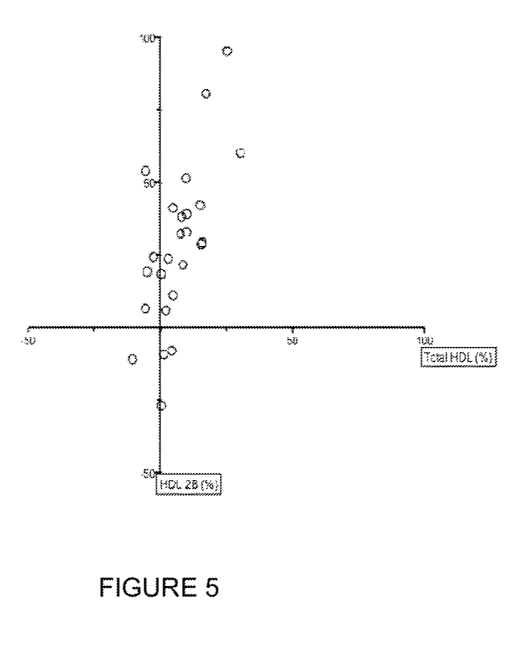

Across the entire cohort, percent changes in HDL2b and HDL-c were highly correlated (p=0.009), as shown in FIG. 5.

Results presented here (Table 13, FIGS. 2-5) indicate that twice daily consumption by healthy adults for 2-weeks in 3 pilot trials of a low calorie, complex-food-based nutrition bar supplemented with vitamins, minerals, essential fatty acids, polyphenolics, and soluble and insoluble fibers and other components (see Methods) results in increased reported satiety, clinically favorable increases (6.2%) in total HDL-c concentration (mg/dL), and a highly significant favorable shift (p<0.0001) toward HDL2b, the largest, most buoyant subclass of HDL. A trend toward an increase in the average size of all LDL particles (p=0.086) was also noted. Hcy also significantly decreased across all 3 trials (Table 13, FIG. 3).

### Example 7. Use of a Mixture of a Soluble Nonfermentable Fiber (β-Glucan) and the Highly Viscous Soluble Nonfermentable Fiber Hydroxypropylmethylcellulose (HPMC)

A 2-month trial utilized a bar containing a mixture of β-glucan and HPMC (same total soluble fiber as previous bars—½ dose of β glucan plus ½ as hydroxypropylmethylcellulose (HPMC; Table 14)).

Participants were advised to discontinue all vitamin, mineral, and fiber supplements and any other nutraceuticals two weeks prior to the initiation of each trial. Compliance with these guidelines as well as absence of intercurrent infectious disease was assessed by self-report. Consumption of 2 bars each day was advised, with the first to be eaten before noon and the second bar in either the afternoon or evening. Subjects were advised to drink a minimum of 8 oz of water with each bar. No guidelines as to whether to use the bar as a meal replacement or a supplement were given, but self-report satiety scores before and 20 min following intake were collected. Baseline and 2-week visits to the clinical research center included measurements of height, weight and waist circumference taken 1 cm above the iliac crest.

TABLE 14

| | Amounts | |
|---|---|---|
| Bar Ingredients | All B vits adjusted to 50% RDA; less coffee | |
| beta carotene | 0.16 | mg |
| biotin | 0.0075 | mg |
| calcium | 275 | mg |
| choline | 124 | mg |
| chromium | 0.0165 | mg |
| copper | 0.09 | mg |
| DHA | 200 | mg |
| 5-methylT4 - folate | 0.2 | mg |
| Glutamine | 1 | g |
| insoluble fiber | 4 g wheat bran | |
| iron | 2 | mg |
| lactate | — | |
| magnesium | 150 | mg |
| manganese | NONE | |
| niacin | 7.5 | mg |
| pantothenic acid | 1.25 | mg |
| potassium | NONE | |
| riboflavin | 0.6 | mg |
| selenium | 0.0055 | mg |
| soluble fiber | 1 g HPMC | |
| | 1 g β glucan | |
| vitamin B6 | 0.65 | mg |
| vitamin B12 | 0.8 | mcg |
| vitamin C | 100 | mg |
| vitamin D3 | (200 | IU) |
| vitamin E (mixed toc) | 5 | mg |
| vitamin K-1 | 0.0375 | mg |
| MK-7 | — | |
| thiamine | 0.4 mg already 40% | |
| whey protein | 2.5 | g |
| zinc | 2.375 | mg |
| Fruit concentrate** | 10 g: 25% each Blueberry, | |
| | Dried Plum, Cranberry, | |
| | Red Grape | |
| Natural blueberry flavor | 0.4 | g |
| Freeze-dried blueberry | — | |
| Dark Chocolate | 10 | g |
| Walnuts | 1 | g |
| Glycerine | 1 | g |
| +/−Espresso beans | +/−1 | g |

| | |
|---|---|
| or citric acid coating | +/−coating |

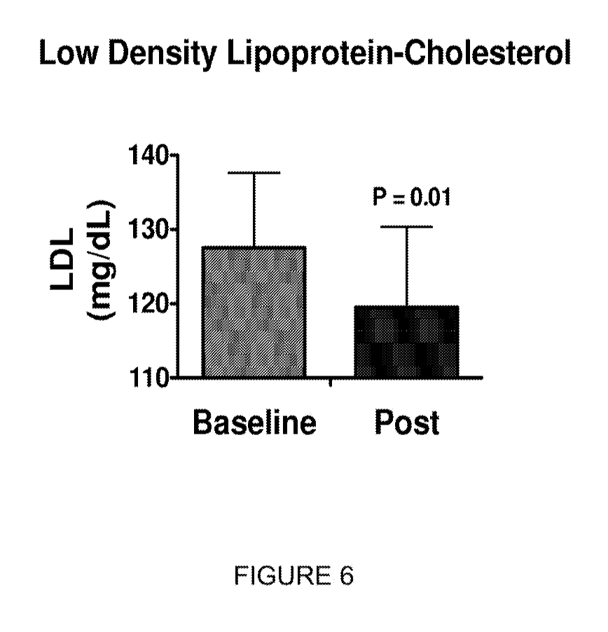

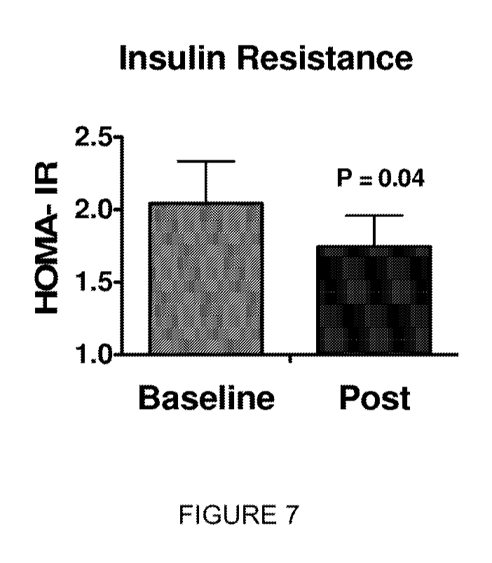

There was no early (2 wk) effect on HDL-c, but a significant increase (p=0.04) occurred by the 2-month time point. A significant decrease in LDL occurred at both the 2-week and 2-month time points; the result at 2-months p=0.01) is depicted in FIG. 6. Interestingly, homocysteine levels did not fall in this trial (data not shown), which we attribute to reduced absorption of B vitamins due to the higher viscosity fiber. Significant improvement was also observed in HOMA/IR, the plasma homeostatic model of insulin resistance, at 2-months (FIG. 7).

### Example 8. A 7-Week Trial in Obese Parents and Adolescents

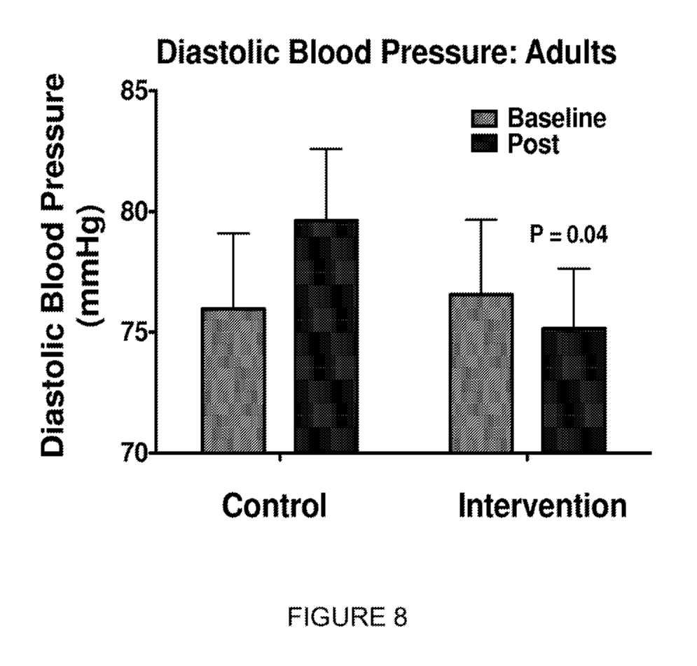

A 7-week trial in Hispanic and African American obese parents and their adolescent children resulted in statistically significant decreases in blood pressure and heart rate in both adults and adolescents who ate the bar, but not in a control group. Blood pressure results are depicted in FIGS. 7 and 8.

For this study, 91% of the adolescents and 70% of adult participants were classified as obese. Obesity was defined in adults as individuals having a Body Mass Index (BMI) greater than 30. Children were considered obese if they had a BMI greater than that of the 95^{th} percentile of all children in their age group. All the adolescents who participated in the trial were over 85 percentile of BMI (cut-off for overweight) and only one adult had a BMI lower than 25.

Consumption of 2 bars each day was advised, with the first to be eaten before noon and the second bar in either the afternoon or evening. Subjects were advised to drink a minimum of 8 oz of water with each bar. Ingredients for the bars used in this study are shown in Table 15.

TABLE 15

| Bar Ingredients | “Parent/Adolescent bar” | |
|---|---|---|
| beta carotene | 0.16 | mg |
| biotin | 0.0075 | mg |
| calcium | Still 275 mg; | |
| | (185 mg as Ca Phosphate; rest as Ca lactate) | |
| choline | 124 | mg |
| chromium | 0.0165 | mg |
| copper | 0.09 | mg |
| DHA | 200 | mg |
| 5-methylT4 - folate | 0.2 | mg |
| Glutamine | 1 | g |
| insoluble fiber | 4 g wheat bran | |
| iron | 2 | mg |
| lactate | 400 | mg |
| magnesium | 150 | mg |
| manganese | NONE | |
| niacin | 7.5 | mg |
| pantothenic acid | 1.25 | mg |
| potassium | NONE | |
| Short chain FOS | 1 | g |
| riboflavin | 0.6 | mg |
| selenium | 0.0055 | mg |
| soluble fiber | 1.8 g β glucan | |
| vitamin B6 | 0.65 | mg |
| vitamin B12 | 0.8 | mcg |
| vitamin C | 100 | mg |
| vitamin D3 | 500 | IU |
| vitamin E (mixed toc) | 5 | mg |
| vitamin K-1 | 0.025 | mg |
| MK-7 | 0.025 | mg |
| thiamine | 0.4 | mg |
| whey protein | 2.5 | g |
| zinc | 2.375 | mg |
| Fruit concentrate** | 5 g Blueberry, 5 g Purple Grape | |
| Natural blueberry flavor | 0.4 | g |
| Freeze-dried blueberry | 5 | g |
| Dark Chocolate | 10 | g |
| Walnuts | 1 | g |
| Glycerine | 1 | g |
| +/−Espresso beans | +/−1 | g |

| | |
|---|---|
| or citric acid coating | +/−coating |

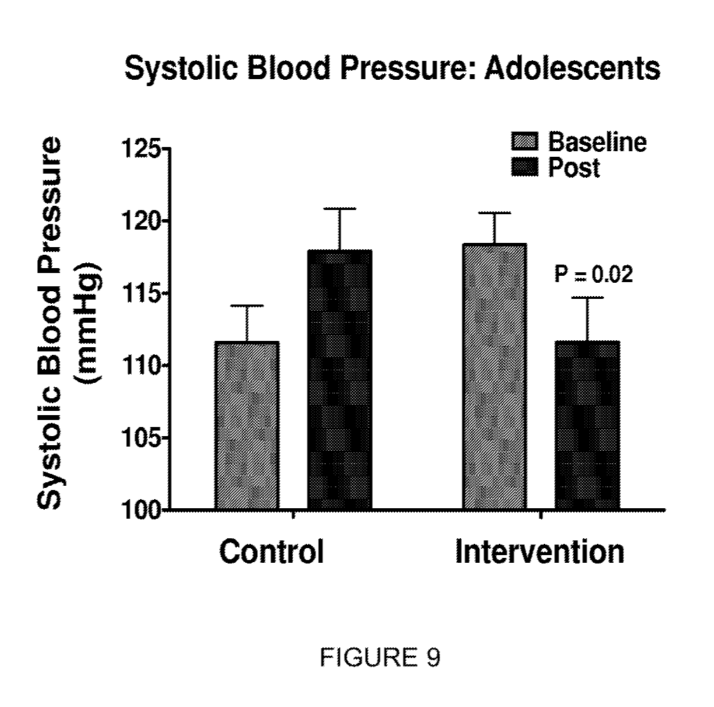

Results for blood pressure are shown in FIG. 8 for adults and FIG. 9 for children. We also observed a significant decrease in diastolic blood pressure in a generally healthy adult cohort in another trial (data not shown).

1. A nutritional composition comprising: a) a fruit component comprising a polyphenol; b) a fiber component comprising a viscous soluble fiber; and c) a micronutrient component, wherein the micronutrient component comprises 1) at least one micronutrient that improves mitochondrial health in an individual; 2) at least one micronutrient that reduces inflammation in an individual; 3) at least one micronutrient that improves immune status in an individual, 4) at least one micronutrient that improves the redox status or antioxidant defense mechanism, and 5) at least one micronutrient that improves gut health.

2. The nutritional composition of claim 1, wherein the micronutrient component further comprises 6) at least one micronutrient that improves lipid metabolism, 7) at least one micronutrient that improves satiety, 8) at least one micronutrient that improves maintenance of DNA integrity, and/or at least one micronutrient that improves vascular function and blood pressure.

3.-5. (canceled)

6. The nutritional composition of claim 3, wherein at least one of the vitamins is selected from the group consisting of beta-carotene, MK7, and 5-methyl-tetrahydrofolate.

7. The nutritional composition of claim 3, wherein said LCPUFA is DHA.

8. The nutritional composition of claim 1, wherein said micronutrient component comprises at least five vitamins listed in Table 1.

9. The nutritional composition of claim 1, wherein said micronutrient component comprises at least three minerals listed in Table 2.

10. (canceled)

11. The nutritional composition of claim 1, further comprising a protein.

12.-14. (canceled)

15. The nutritional composition of claim 1, wherein said fruit component comprises potassium.

16. The nutritional composition of claim 1, wherein the viscous soluble fiber is a fermentable viscous soluble fiber.

17. The nutritional composition of claim 16, wherein said fermentable viscous soluble fiber is beta-glucan.

18. The nutritional composition of claim 1, further comprising a water insoluble fiber.

19. (canceled)

20. The nutritional composition of claim 1, wherein the composition comprises all ingredients listed in Table 3 or Table 4.

21. The nutritional composition of claim 1, wherein the composition comprises all ingredients listed in Table 5, Table 6, Table 9, Table 10, Table 11, Table 14, or Table 15.

22. The nutritional composition of claim 1, wherein the nutritional composition is in the form of a nutrition bar.

23. A sealed package comprising a nutritional composition of claim 1.

24. (canceled)

25. A method of maintaining metabolic balance in an individual comprising administering a nutritional composition of claim 1 to the individual.

26.-31. (canceled)

32. A method of making a nutritional composition comprising a fruit component and a micronutrient, comprising combining a dried form of the fruit component with the powdered micronutrient blend prior to combining with other ingredients.
